(19) United States
(12) Patent Application Publication
(10) Pub. No.: US 2026/0304009 A1
(43) Pub. Date: Oct. 1, 2026

(54) SOLID-STATE IMAGING DEVICE INCLUDING A DRIVING CONTROL CIRCUIT FOR CORRECTING A NON-LINEAR REGION OF A RAMP SIGNAL

(71) Applicant: Samsung Electronics Co., Ltd., Suwon-si (KR)

(72) Inventors: Nobuo Nakamura, Yokohama (JP); Yasutaka Kimura, Yokohama (JP); Tomohiko Sato, Yokohama (JP)

(21) Appl. No.: 19/575,060

(22) Filed: Mar. 23, 2026

(30) Foreign Application Priority Data
Mar. 25, 2025 (JP) 2025-049289

(51) Int. Cl. H04N 25/78; H04N 25/616; H04N 25/703

(52) U.S. Cl. CPC H04N 25/78; H04N 25/616; H04N 25/703

(57) ABSTRACT

A solid-state imaging device includes a reference pixel configured to output a reference pixel signal, a ramp generator configured to output a ramp signal having a slope that changes from a first slope to a second slope at a change point, a comparator configured to compare the ramp signal with a pixel signal generated from a pixel, a counter configured to receive a comparison result from the comparator and generate a counter value as a digital pixel value of the pixel signal, and a driving control circuit configured to correct, based on the reference pixel signal, a non-linear region that occurs as the slope of the ramp signal is changed.

### CROSS-REFERENCE TO RELATED APPLICATIONS

This application is based on and claims priority under 35 U.S.C. § 119 to Japanese Patent Application No. 10-2025-049289, filed on Mar. 25, 2025, in the Japan Patent Office, the disclosures of which are incorporated by reference herein in their entireties.

### BACKGROUND

The disclosure relates to a solid-state imaging device. More particularly, the disclosure relates to a solid-state imaging device capable of correcting non-linear regions that are generated when the slope of a ramp signal changes at a change point.

In a solid-state imaging device such as a Complementary Metal Oxide Semiconductor (CMOS) image sensor, an Analog-to-Digital (AD) converter including a ramp generator for generating ramp signals and a comparison unit for comparing the ramp signals with pixel signals is used as an AD converter used for AD conversion of pixel signals that are output from pixels.

In such an AD converter, because a ramp voltage is changed in synchronization with a clock signal, it takes a relatively longer time to perform AD conversion.

According to the related art, in an AD converter of a ramp modulation type, ramp steps are configured to increase according to an increase in input signals. The increase in the ramp steps corresponds to an increase in the slope of ramp signals with respect to time. Accordingly, AD conversion of pixel signals may be accelerated. For example, when the pixel signal is larger, the AD converter increases how fast the ramp voltage rises. Because the ramp rises faster, the comparator detects equality sooner, and the analog-to-digital conversion finishes more quickly.

### SUMMARY

When the slope of a ramp signal is changed while a pixel signal is Analog-to-Digital (AD)-converted using the ramp signal, a delay occurs due to parasitic capacitance of wiring configured to transmit the ramp signal to a comparison unit, or the like. To this end, a non-linear transition region occurs until the slope of the ramp signal reaches a slope after the change, which degrades AD conversion accuracy.

The disclosure provides a solid-state imaging device capable of reducing the time required for AD conversion while suppressing a decrease in AD conversion accuracy of pixel signals.

According to an aspect of the present disclosure, a solid-state imaging device includes a reference pixel configured to output a reference pixel signal, a ramp generator configured to output a ramp signal having a slope that changes from a first slope to a second slope at a change point, a comparator configured to compare the ramp signal with a pixel signal generated from a pixel, a counter configured to receive a comparison result from the comparator and generate a counter value as a digital pixel value of the pixel signal, and a driving control circuit configured to correct, based on the reference pixel signal, a non-linear region that occurs as the slope of the ramp signal is changed.

According to an aspect of the present disclosure, a solid-state imaging device includes a pixel array comprising a plurality of pixels arranged in a plurality of columns and a plurality of rows, a reference pixel array comprising a plurality of reference pixels arranged in the plurality of columns and a plurality of rows, a ramp generator configured to output a ramp signal having a slope that changes from a first slope to a second slope at a first change point, a driving control circuit configured to correct a non-linear region of the ramp signal after the first change point, and a memory configured to store data used to correct the non-linear region.

According to an aspect of the present disclosure, a solid-state imaging device includes a pixel array comprising a plurality of pixels arranged in a plurality of columns and a plurality of rows, a reference pixel array comprising a plurality of reference pixels arranged in the plurality of columns and a plurality of rows, a ramp generator configured to output a ramp signal of which a slope is changed at a change point, and a driving control circuit configured to correct a non-linear region of the ramp signal after the change point, based on outputs from the plurality of reference pixels, wherein a light-blocking layer is provided on the plurality of reference pixels.

According to an aspect of the present disclosure, a solid-state imaging device includes a pixel array including a plurality of pixels arranged in a row direction and a column direction, a reference pixel array configured to output a reference pixel signal, a ramp generator configured to generate a ramp signal having a slope that changes from a first slope to a second slope at a change point to perform analog-to-digital (AD) conversion of signals from the pixel array and the reference pixel array, a memory configured to store a delay amount, the delay amount being a difference between a measured signal amount of the reference pixel signal and an ideal value calculated based on the second slope, and a correction unit configured to compare a digital pixel value from the pixel array with a change point setting value of the change point, and correct the digital pixel value using the delay amount and a gain restoration factor when the digital pixel value reaches the change point to generate a corrected signal component.

### BRIEF DESCRIPTION OF THE DRAWINGS

Embodiments will be more clearly understood from the following detailed description taken in conjunction with the accompanying drawings in which:

FIG. 1 illustrates an embodiment of a solid-state imaging device;

FIG. 2 illustrates an embodiment of a pixel;

FIG. 3 illustrates an example of a ramp signal;

FIG. 4 is a timing chart illustrating a readout operation and an Analog-to-Digital (AD) conversion operation of a general pixel signal;

FIG. 5 illustrates an example of a flow for calculating a constant delay amount for all columns in a row direction by using reference pixel signals of a reference pixel array;

FIG. 6 illustrates an example of a flow for correcting a pixel signal of a pixel array with a calculated delay amount;

FIG. 7A illustrates an example of a ramp signal when a value identical to a reset inversion clock count detected from each reference pixel of a reference pixel array is set as a change point;

FIG. 7B illustrates an example of a ramp signal when a value that is greater than a reset inversion clock count detected from each reference pixel of a reference pixel array is set as a change point;

FIG. 8 is a timing diagram showing an example of timing at which information of a reference pixel of a reference pixel array is stored in a memory;

FIG. 9 is a timing diagram of an example of timing at which information of a pixel of a pixel array is stored in a memory;

FIG. 10 illustrates an example of assignment of a change point and a calculated delay amount to each row of a reference pixel array when a delay amount is calculated for each row by using the reference pixel array;

FIG. 11 illustrates an example of a circuit configuration of a comparison unit;

FIG. 12 illustrates an example of a ramp circuit configuration of a Digital-to-Analog Converter (DAC) circuit;

FIG. 13 illustrates another example of a ramp circuit configuration of a DAC circuit;

FIG. 14 illustrates an example of a device structure of a solid-state imaging device;

FIG. 15 illustrates an example of a flow for calculating a delay amount for each row and each column by using reference pixel signals of a reference pixel array;

FIG. 16 illustrates an example of a flow for correcting a pixel signal of a pixel array with a calculated delay amount;

FIG. 17 is a diagram for explaining an effect by non-uniformity among columns on a reset level of reference pixels in the same row;

FIG. 18 illustrates an example of assignment of a change point and a calculated delay amount to each reference pixel of a reference pixel array when a delay amount is calculated for each reference pixel by using the reference pixel array;

FIG. 19A illustrates an example of a relationship between a reset signal amount of a pixel and a control count when a pixel signal amount is less than a change point;

FIG. 19B illustrates an example of a relationship between a pixel signal amount of a pixel and a control count when the pixel signal amount is less than a change point;

FIG. 20A illustrates an example of a relationship between a reset signal amount of a reference pixel and a control count when a reference pixel signal amount is equal to or greater than a change point;

FIG. 20B illustrates an example of a relationship between a pixel signal amount of a pixel and a control count when a reference pixel signal amount is equal to or greater than a change point;

FIG. 21A illustrates an example of a relationship between a reset signal amount of a reference pixel and a control count when a reference pixel signal amount is equal to or greater than a change point;

FIG. 21B illustrates an example of a relationship between a pixel signal amount of a pixel and a control count when a reference pixel signal amount is equal to or greater than a change point;

FIG. 22 illustrates a comparison between an example of a ramp signal having a changed slope at a change point and an existing ramp signal having an unchanged slope;

FIG. 23 illustrates a comparison between an example of a ramp signal having a changed slope at a change point and an existing ramp signal having an unchanged slope;

FIG. 24 illustrates a comparison between an example of a ramp signal having a changed slope at a change point and an existing ramp signal having an unchanged slope;

FIG. 25 illustrates a comparison between an example of a ramp signal having a changed slope at a change point and an existing ramp signal having an unchanged slope;

FIG. 26 illustrates a comparison between an example of a ramp signal having a changed slope at a change point and an existing ramp signal having an unchanged slope;

FIG. 27 illustrates a comparison between an example of a ramp signal having a changed slope at a change point and an existing ramp signal having an unchanged slope;

FIG. 28 illustrates a comparison between an example of a ramp signal having a changed slope at a change point and an existing ramp signal having an unchanged slope;

FIG. 29 illustrates a comparison between an example of a ramp signal having a changed slope at a change point and an existing ramp signal having an unchanged slope;

FIG. 30 illustrates a comparison between an example of a ramp signal having a changed slope at a change point and an existing ramp signal having an unchanged slope;

FIG. 31 illustrates a comparison between an example of a ramp signal having a changed slope at a change point and an existing ramp signal having an unchanged slope;

FIG. 32 illustrates a comparison between an example of a ramp signal having a changed slope at a change point and an existing ramp signal having an unchanged slope;

FIG. 33 illustrates an example of a split-photodiode (PD) structure in which Dual Conversion Gain (DCG) is implemented; and

FIG. 34 illustrates an example of a structure in which an analog gain of AD conversion is changed to one half by reducing a clock frequency of a counter circuit to one half.

### DETAILED DESCRIPTION OF THE EMBODIMENTS

Hereinafter, a solid-state imaging device is described in detail with reference to the attached drawings. One or more embodiments to be described below are merely examples, and various modifications may be made to the one or more embodiments. Like reference numerals in the drawings denote like elements, and sizes of components in the drawings may be exaggerated for convenience of explanation.

Throughout the specification, terms “upper” and “above” include not only components that are directly above, below, to the left, or to the right in contact with one another, but also components that are positioned in such directions in a non-contact manner.

While such terms as “first,” “second,” etc., may be used to describe various components, the above terms are used only to distinguish one component from another. Such terms are not intended to imply any difference in materials or structures of components.

The singular forms “a,” “an,” and “the” are intended to include the plural forms as well, unless the context clearly indicates otherwise. It will be further understood that the terms “comprises” and/or “comprising” used herein specify the presence of stated features or components, but do not preclude the presence or addition of one or more other features or components.

Also, the terms “. . . unit,” “. . . module,” etc. are units for processing at least one function or operation and may be implemented as hardware, software, or a combination of hardware and software.

In addition, the terms “row” and “column” each refer to a direction in which pixels, etc. are aligned, and such terms may be interchangeably used.

In addition, the term “simultaneous” may include not only cases in which events occur at exactly the same time, but also cases in which simultaneity is intended based on control, even though events do not occur at exactly the same time due to effects of element non-uniformity, parasitic elements, or the like.

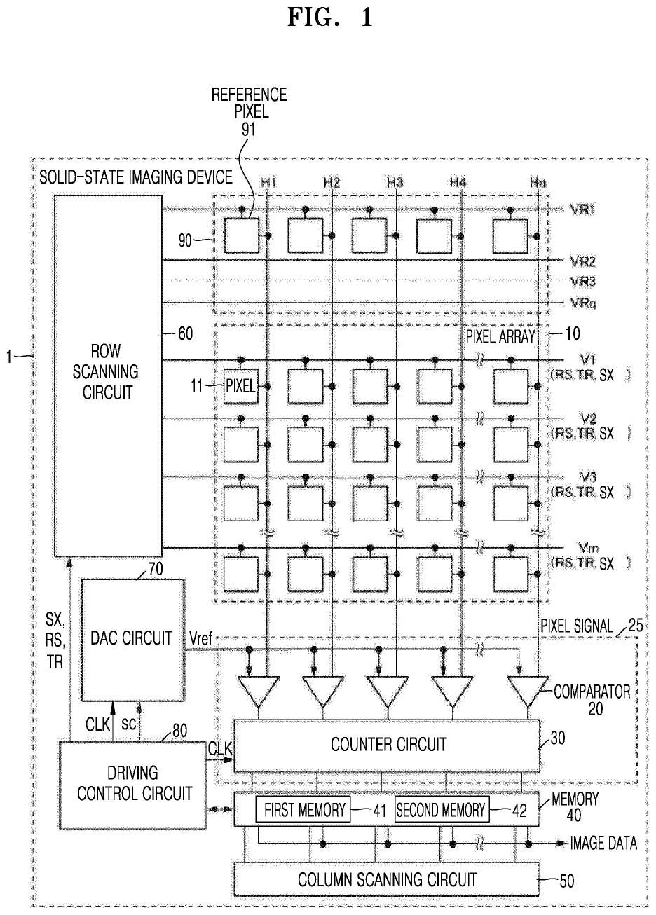

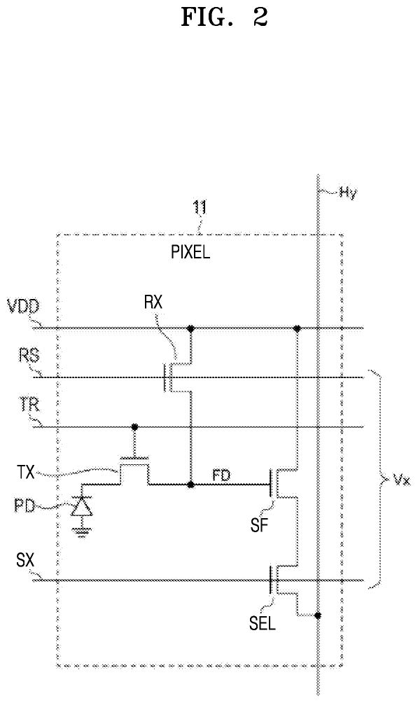

FIG. 1 illustrates a structure of a solid-state imaging device 1. FIG. 2 illustrates a structure of a pixel 11.

Referring to FIG. 1, the solid-state imaging device 1 includes a pixel array 10, a comparison unit 20, a counter circuit 30, a memory 40, a column scanning circuit 50, a row scanning circuit 60, a Digital-to-Analog Converter (DAC) circuit 70, a driving control circuit 80, and a reference pixel array 90. The comparison unit 20 and the counter circuit 30 may constitute an Analog-to-Digital Converter (ADC) circuit 25. The counter circuit 30 may be an adaptive slope-type ADC and constitute a conversion unit. The comparison unit 20 may constitute a comparator (i.e., a comparator circuit). The DAC circuit 70 may constitute a ramp generator. The driving control circuit 80 may constitute a correction unit.

The pixel array 10 may include a plurality of pixels 11 arranged in rows and columns. Hereinafter, a direction in which the plurality of pixels 11 are arranged in rows may be referred to as a “row direction.” A direction in which the plurality of pixels 11 are arranged in columns may be referred to as a “column direction.”

The reference pixel array 90 may include a plurality of reference pixels (unit reference pixels) 91 arranged in rows and columns. The reference pixel array 90 may have the same configuration as the pixel array 10, but in the reference pixel array 90, a light-blocking layer (not shown) for preventing light from being irradiated onto the plurality of reference pixels 91 may be provided on the plurality of reference pixels 91. The light-blocking layer may include, for example, metal. The plurality of reference pixels 91 of the reference pixel array 90 may be arranged in an array in columns common to the pixels 11 of the pixel array 10. The number of rows of the reference pixels 91 in the reference pixel array 90 may be less than the number of rows of the pixels 11 in the pixel array 10.

Referring to FIGS. 1 and 2, the pixel 11 includes a photodiode PD, a transfer transistor TX, a reset transistor RX, a source follower transistor SF, and a selection transistor SEL.

Row control lines V1 to Vm controlled by the row scanning circuit 60 may be connected to the pixels 11. The row control lines V1 to Vm are configured to transmit control signals for selecting pixels 11 for reading out pixel signals for respective rows. Each of the row control lines V1 to Vm includes a reset signal line RS, a transfer signal line TR, and a selection signal line SX. The selection signal line SX is configured to transmit a control signal for selecting a pixel 11 for reading out a pixel signal. The transfer signal line TR is configured to transmit a control signal for outputting a voltage of the photodiode PD (an output voltage) to a floating diffusion region FD. The reset signal line RS is configured to transmit a control signal for resetting a voltage of the floating diffusion region FD.

The pixels 11 are connected to column signal lines H1 to Hn configured to transmit, to the comparison unit 20, pixel signals that are output (read out) from the pixels 11 on a column-by-column basis.

The reference pixels 91 are connected to row control lines VR1 to VRq controlled by the row scanning circuit 60. The row control lines VR1 to VRq are configured to transmit control signals for selecting reference pixels 91 for reading out reference pixel signals on a row-by-row basis. Similar to each of the row control lines V1 to Vm, each of the row control lines VR1 to VRq may include a reset signal line RS, a transfer signal line TR, and a selection signal line SX. The selection signal line SX of the reference pixel array 90 is configured to transmit a control signal for selecting a reference pixel 91 for reading out a reference pixel signal. The transfer signal line TR is configured to transmit a control signal for outputting a voltage (an output voltage) of the photodiode PD of the reference pixel 91 to the floating diffusion region FD of the reference pixel 91. The reset signal line RS is configured to transmit a control signal for resetting the voltage of the floating diffusion region FD of the reference pixel 91.

The reference pixels 91 are connected to the column signal lines H1 to Hn configured to transmit, to the comparison unit 20, reference pixel signals that are output (read out) from the reference pixels 91 on a column-by-column basis. As described above, the column signal lines H1 to Hn may be lines configured to transmit, to the comparison unit 20, pixel signals that are output from the pixels 11 of the pixel array 10 on a column-by-column basis.

The row scanning circuit 60 is configured to generate and output control signals for selecting pixels 11 for reading out pixel signals from respective rows through the row control lines V1 to Vm. A pixel signal is output from each pixel 11 in a single row selected based on a corresponding control signal and is input to the comparison unit 20 through each of the column signal lines H1 to Hn.

Furthermore, the row scanning circuit 60 generates and outputs control signals for selecting reference pixels 91 for reading out reference pixel signals from respective rows through the row control lines VR1 to VRq. A reference pixel signal is output from each reference pixel 91 in a single row selected based on a corresponding control signal and is input to the comparison unit 20 through each of the column signal lines H1 to Hn.

The DAC circuit 70 generates and outputs a ramp signal Vref based on a control signal SC. The ramp signal Vref may be a voltage that decreases in proportion to time (according to an embodiment, the number of transitions of a clock signal). In an embodiment, the number of transitions of the clock signal (i.e., a digital count) may represent the time elapsed after the DAC circuit 70 starts to generate the ramp signal Vref.

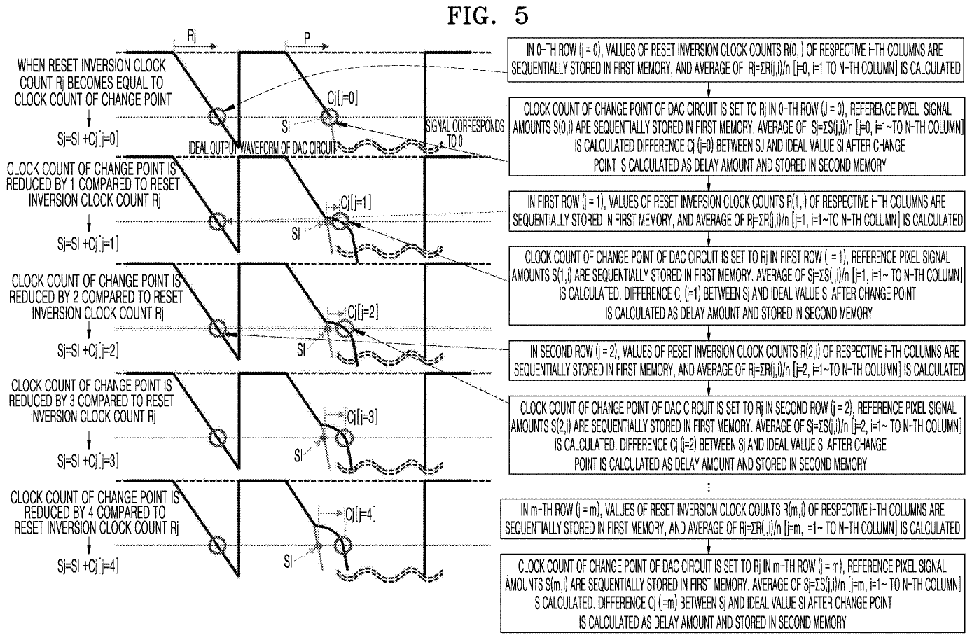

The DAC circuit 70 outputs the ramp signal Vref of which a slope is changed at a specific change point. Hereinafter, a change point of the ramp signal Vref is also referred to as a “change point.” For example, the change point may correspond to a time point when the slope changes. The DAC circuit 70 may output a ramp signal Vref of which a slope is increased at a change point. The control signal SC may include information regarding the change point. According to an embodiment, the control signal SC may include information regarding coordinates of the change point. Changing the slope of the ramp signal Vref corresponds to changing an analog gain of the ramp signal Vref with respect to a clock. For example, the control signal SC may specify when the ramp slope changes during conversion. Changing the ramp slope changes how much the ramp voltage increases per clock cycle, which is equivalent to changing the analog gain of the DAC circuit 70 relative to clock pulses. In an embodiment, for Correlated Double Sampling (CDS), the ramp signal may be applied to a comparator to convert both a reset level and a signal level into corresponding digital values, and correlated double sampling is performed based on a difference between the digital values. A portion of the ramp signal for sampling the signal level may have the change point, as shown in FIG. 5, for example. Hereinafter, for simplification of explanation, a case where the slope of the ramp signal Vref is doubled at a change point is described, unless otherwise stated. In other words, a case where the analog gain of the ramp signal Vref is changed from 1 to ½ at the change point is described. In an embodiment, the slope of the ramp signal may be defined as a rate of voltage change per unit time, expressed as dV/dt, and may be determined by a ratio of a ramp current supplied to a ramp capacitor. The change point is a time point when a slope of the ramp signal Vref is changed. The analog gain of the ramp signal refers to the inverse of the ramp slope and represents the voltage-to-time conversion sensitivity of the ADC circuit 25.

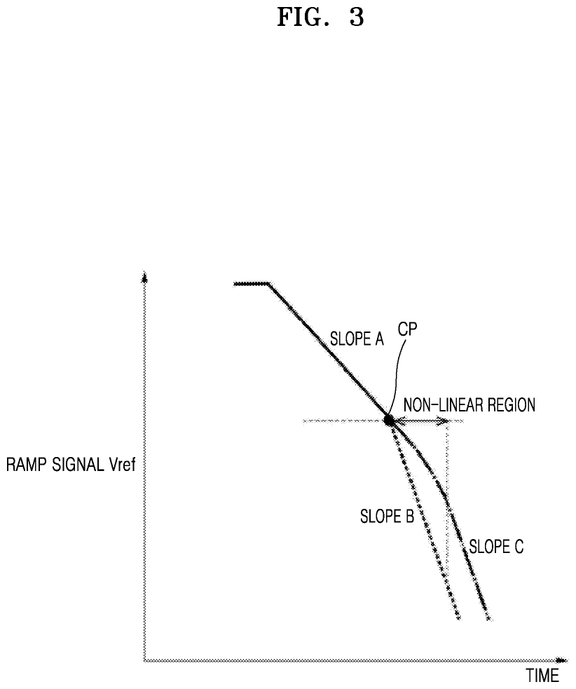

FIG. 3 illustrates an example of the ramp signal Vref. In the example illustrated in FIG. 3, the slope of the ramp signal Vref with respect to time changes from a slope A (the slope indicated by a solid line) to a slope B (the slope indicated by a dashed line) at a change point CP indicated by a black circle. However, because the ramp signal Vref Is transmitted via wiring to a plurality of comparison units 20 arranged in the row direction, a non-linear region occurs due to a delay caused by parasitic capacitance of wiring or the like, and thus, a waveform from the change point CP is represented by a dash-dotted line. The non-linear region is indicated by a bidirectional arrow in FIG. 3. In other words, the ramp signal Vref transitions from the change point CP through the non-linear region that is a transition region and reaches a slope C after the change. As the non-linear region is generated, the accuracy of AD conversion may be degraded. For example, at the change point CP, the ramp signal Vref enters the non-linear transition region before stabilizing to the slope C after the change. The presence of this non-linear transition region may degrade the linearity and thus the accuracy of the AD conversion. In an embodiment, the slope B may be a target slope, and due to the delay, the ramp signal Vref is subject to the non-linear transition region before reaching the slope C. In an embodiment, the magnitude of the slope C may be the same as that of the slope B.

Referring back to FIG. 1, the comparison unit 20 compares the ramp signal Vref with a pixel signal (according to an embodiment, a voltage of a pixel signal) transmitted through the column signal lines H1 to Hn and outputs a comparison result. The comparison unit 20 outputs a high level when the pixel signal is equal or lower than the ramp signal Vref and outputs a low level when the pixel signal is higher than the ramp signal Vref.

Moreover, the comparison unit 20 compares the ramp signal Vref with a reference pixel signal (according to an embodiment, a voltage of the reference pixel signal) transmitted through the column signal lines H1 to Hn and outputs a comparison result. The comparison unit 20 outputs a high level when the reference pixel signal is equal or lower than the ramp signal Vref and outputs a low level when the reference pixel signal is higher than the ramp signal Vref.

The counter circuit 30 starts counting clock signals (e.g., clock pulses) by using a clock signal CLK simultaneously with the initiation of output of the ramp signal Vref that is input to the comparison unit 20, and counts the clock signals until the ramp signal Vref becomes lower than the pixel signal, thereby outputting a count result. For example, an analog pixel voltage may be converted into a time duration using the ramp signal, and the time is converted into a digital value using the counter.

Moreover, the counter circuit 30 starts counting clock signals by using a clock signal CLK simultaneously with the initiation of output of the ramp signal Vref that is input to the comparison unit 20, and counts the clock signals until the ramp signal Vref becomes lower than the reference pixel signal, thereby outputting a count result.

Through the operations of the comparison unit 20 and the counter circuit 30, a pixel signal and a reference pixel signal of each column in a single row are respectively AD-converted (i.e., are respectively converted into digital values). Hereinafter, the pixel signal and the reference pixel signal, which are AD-converted, are respectively referred to as “pixel signal amount” and “reference pixel signal amount.” The pixel signal amount may be interchangeably used with a digital pixel value. The reference pixel signal amount may be interchangeably used with a digital reference pixel value.

The memory 40 may store, for each pixel 11, a pixel signal amount that is a count result (i.e., a count value) obtained by AD conversion of the pixel signal. As described below, a voltage output from the pixel 11 (a reset component Vrst) is AD-converted immediately after a voltage of the floating diffusion region FD is reset by a reset control signal transmitted through the reset signal line RS, and is subtracted from a pixel signal amount. Accordingly, a signal component Vsig from which effects such as noise and the like in the pixel signal amount are removed may be obtained. The pixel signal amount may include a reset component Vrst and the signal component Vsig. As described below, a reset level Vrst of the floating diffusion region FD is analog-to-digital converted immediately after the FD is reset by a reset control signal transmitted through the reset signal line RS. After charge corresponding to incident light is transferred to the floating diffusion region FD, a signal level is read and analog-to-digital converted. The reset level is subtracted from the signal level to obtain a signal component Vsig, whereby reset noise and offset components are reduced through correlated double sampling.

Furthermore, similar to the pixel signal amount that is a count result produced by AD conversion of the pixel signal, the memory 40 may store, for each reference pixel 91, a reference pixel signal amount that is a count result produced by AD conversion of the reference pixel signal.

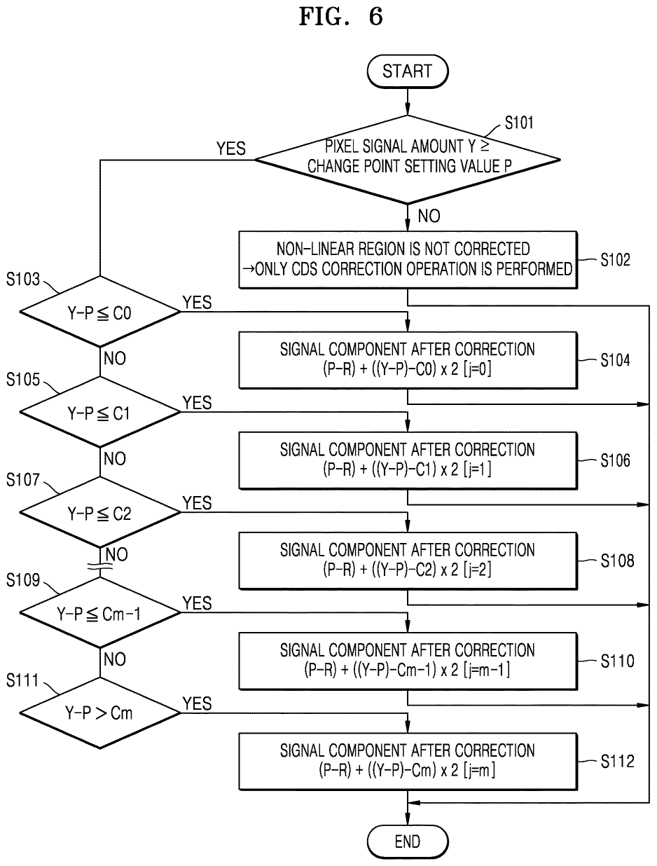

Hereinafter, a case where the memory 40 includes a first memory 41 and a second memory 42 is described. According to an embodiment, the memory 40 may store data used to correct the non-linear region. The term “correct the non-linear region” refers to a mathematical compensation process performed by the driving control circuit (correction unit) to restore linearity and conversion accuracy. The first memory 41 may store a reset inversion clock count corresponding to a reference pixel 91 and a reference pixel signal amount, and the second memory 42 may store a delay amount corresponding to a difference between a reference pixel signal amount calculated for each column and an ideal value. Alternatively, the second memory 42 may store a delay amount corresponding to a difference between an average of the reference pixel signal amount and the ideal value on a row-by-row basis. This will be described in more detail with reference to FIGS. 5 and 6.

The driving control circuit 80 may receive control data used to set a master clock signal or timing settings from an external device such as a Digital Signal Processor (DSP), generate and output various clock signals, and control overall operation of the solid-state imaging device 1.

The driving control circuit 80 may output a control signal SC to the DAC circuit 70 and control the change point and the slope of the ramp signal Vref generated by the DAC circuit 70 by control signal SC. The change point that is finally set may be set based on an instruction from a user.

As described below, the driving control circuit 80 may correct the non-linear region of the ramp signal Vref by using the reference pixel signal. In detail, the driving control circuit 80 may read, from the memory 40, a reference pixel signal amount obtained through AD conversion of a reference pixel signal and may correct the non-linear region of the ramp signal Vref by using the reference pixel signal amount. More specifically, the driving control circuit 80 may calculate a difference between the reference pixel signal amount and an ideal value SI of the ramp signal Vref after the slope change as a delay amount. For example, the ideal value SI is a reference pixel signal amount calculated on the assumption that no non-linear region is generated when the ramp slope changes. More specifically, when the slope of the ramp signal Vref changes from slope A to slope B as shown in FIG. 3, the ideal value SI is a reference signal amount calculated based on the ramp signal of the slope B. The driving control circuit 80 may correct the pixel signal amount by using the calculated delay amount and the change point. Such correction may correspond to calculating the pixel signal amount by correcting the non-linear region of the ramp signal Vref when the pixel signal amount is greater than the change point.

The driving control circuit 80 may include a Central Processing Unit (CPU) and perform calculation and control according to a program. In an embodiment, the program may implement the sequences as described with reference to FIG. 6. The present disclosure is not limited thereto. In an embodiment, the driving control circuit 80 may be implemented using a circuit performing functions executed by the program. In an embodiment, the driving control circuit 80 may be implemented using a hybrid of a program and a circuit to perform various functions.

The column scanning circuit 50 may read, from the memory 40, a signal component Vsig of a pixel signal amount stored for each pixel 11 and may integrate the signal component Vsig as frame-based image data and output the same.

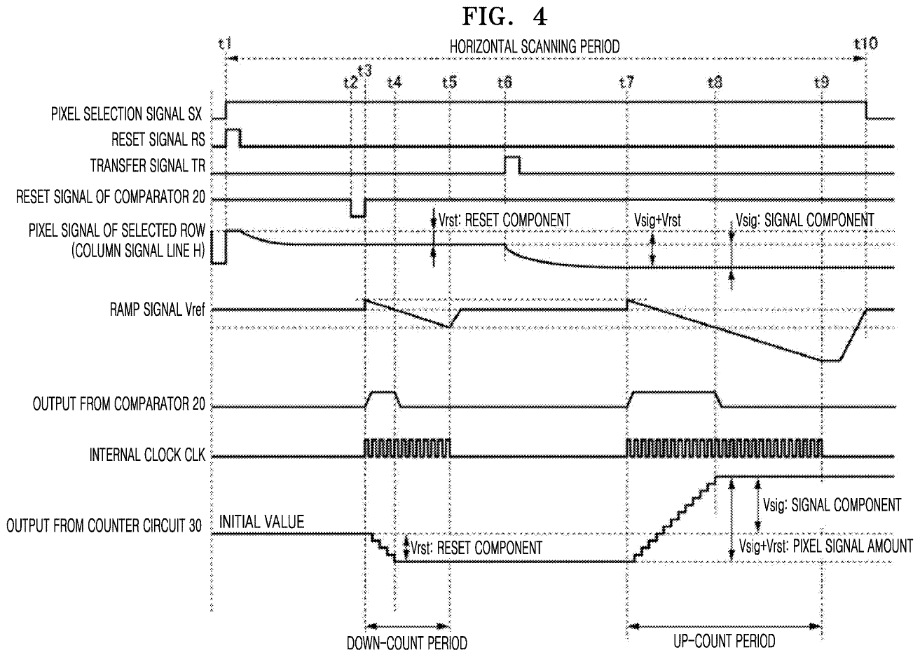

FIG. 4 is a timing chart illustrating a readout operation and an AD conversion operation of a pixel signal, according to an embodiment. The timing chart of FIG. 4 represents a timing chart of a read operation and an AD conversion operation of a pixel signal and does not illustrate correction of a non-linear region.

FIG. 4 is a timing chart of a read operation and an AD conversion operation of a pixel signal (voltage) of a pixel 11 connected to a selected row control line Vx.

The driving control circuit 80 (see FIG. 1) turns on a selection transistor SEL of the pixel 11 by transitioning a level of a selection signal line SX to a high level at a point in time t1, thereby selecting a plurality of pixels 11 connected to an arbitrary row control line Vx.

The driving control circuit 80 turns on a reset transistor RX by setting a level of a reset signal line RS to a high level while keeping the transfer transistor TX turned off by setting a level of a transfer signal line TR to a low level. Accordingly, the voltage of the floating diffusion region FD is reset.

Next, the driving control circuit 80 turns off the reset transistor RX by setting the level of the reset signal line RS to a low level after a certain period of time has passed.

The driving control circuit 80 initializes the comparison unit 20 in response to a reset control signal (i.e., a reset signal of comparator) at a point in time t2.

At a point in time t3, the driving control circuit 80 may complete the initialization of the comparison unit 20 in response to the reset control signal, and at the same time, the DAC circuit 70 sets the ramp signal Vref as an initialization voltage and initializes an output of the comparison unit 20 to a high level (an initial value).

At the point in time t3, the driving control circuit 80 starts supplying the clock signal CLK to the counter circuit 30 and the DAC circuit 70. The comparison unit 20 compares the ramp signal Vref with the reset component Vrst of the pixel 11 that is output to each of the column signal lines H1 to Hn, and the counter circuit 30 starts a down count from an initial value (a reset value of 0).

At a point in time t4, the comparison unit 20 inverts the output from a high level to a low level when the ramp signal Vref becomes equal to a reset component Vrst (a reset signal) of the pixel 11 in a Vx-th row that is input through the column signal lines H1 to Hn.

By comparing the reset component Vrst with the ramp signal Vref, a value corresponding to the magnitude of the reset component Vrst is counted based on the clock signal CLK, and thus, a count value corresponding to the magnitude of the reset component Vrst may be obtained. The count value corresponds to a reset inversion clock count R described below.

When a certain down-count period has passed (a point in time t5), the driving control circuit 80 may stop supplying signals such as the ramp signal Vref to the comparison unit 20 and supplying the clock signal CLK to the DAC circuit 70 and the counter circuit 30.

Then, the driving control circuit 80 turns on the transfer transistor TX by setting the level of the transfer signal line TR to a high level at a point in time t6. Accordingly, the photocharges accumulated in the photodiode PD are transmitted to the floating diffusion region FD. Then, the driving control circuit 80 turns off the transfer transistor TX by setting the level of the transfer signal line TR to a low level.

The DAC circuit 70 sets the ramp signal Vref to have an initialization voltage again at a point in time t7 and initializes the output of the comparison unit 20 to a high level (an initial value).

The driving control circuit 80 respectively supplies the clock signals CLK to the counter circuit 30 and the DAC circuit 70. The comparison unit 20 starts comparing the ramp signal Vref with read data components Vrst+Vsig that are pixel signals respectively output to the column signal lines H1 to Hn. In other words, the counter circuit 30 starts an up-count from the count value at which the above-described down-count is stopped.

At a point in time t8, the comparison unit 20 inverts the output from a high level to a low level when the ramp signal Vref becomes the same as the read data component Vrst+Vsig that is a pixel signal of the pixel 11 in the Vx-th row that is input through the column signal lines H1 to Hn. Accordingly, by comparing the ramp signal Vref with the read data component Vrst+Vsig that is a pixel signal, a value corresponding to the magnitude of the read data component Vrst+Vsig that is a pixel signal is counted based on the clock signal CLK. By performing up-count from the count value at which the above-described down-count is stopped, a count value of the signal component Vsig obtained by subtracting the reset component Vrst from the read data component Vrst+Vsig, which is a pixel signal amount obtained through AD conversion of the pixel signal, may be obtained as an output of the counter circuit 30. As described above, calculating a count value of the signal component Vsig by subtracting the reset component Vrst from the read data component Vrst+Vsig is referred to as Correlated Double Sampling (CDS).

When a certain up-count period has passed (a point in time t9), the driving control circuit 80 may stop the supply of signals such as the ramp signal Vref to the comparison unit 20 and the supply of the clock signal CLK to the DAC circuit 70 and the counter circuit 30.

Then, at a point in time t10, the driving control circuit 80 sets the level of the selection signal line SX to a low level to turn off the selection transistor SEL of the pixel 11, thereby deselecting the pixels 11 connected to the row control line Vx. Accordingly, the AD conversion of the row of the pixel 11 connected to the row control line Vx of the pixel array 10 is completed.

Hereinafter, according to an embodiment, AD conversion of a pixel signal in which a non-linear region of the ramp signal Vref is corrected is described.

FIG. 5 illustrates a sequence of calculating a constant delay amount Cj for all columns in a row direction by using the reference pixel signals of the reference pixel array 90. For example, the constant delay amount Cj may refer to the same delay amount for pixels in the same row. Here, j indicates a row number. FIG. 6 illustrates a flow for correcting pixel signals of the pixel array 10 with the calculated delay amount Cj. The row number may represent a length of a signal path from a comparator to a corresponding row line. For example, when the row number is 0, the row line may be the closest row line to the comparator. Because the signal path length between the comparator and each row line may differ, the delay amount Cj may vary accordingly. In general, a greater distance corresponds to a larger delay amount Cj.

As illustrated in the example of FIG. 5, the delay amount Cj is calculated, for each row, as an average of differences between the ideal value SI of the ramp signal Vref after the slope change and the reference pixel signal amounts. For example, the ideal value SI is a number of counts of a reference pixel which is calculated based on the target slope of a ramp signal without a non-linear transition region, and the reference pixel signal amount is a measured number of counts using a ramp signal in a non-linear transition region. The delay amount Cj may be calculated for each difference by varying the difference between the reference pixel signal amount and the change point. Specifically, the following operations (1) to (6) are performed.
(1) In the 0-th row (j=0), the value of the reset inversion clock count R(0,i) of each column i is sequentially stored in the first memory. An average Rj (j=0) of the reset inversion clock counts (R(0,i)) of respective columns in the 0-th row is calculated. For example, when a number of columns is 1024, the sum of R(0,0) to R(0,1023) is divided by 1024 to obtain the average Rj (j=0).

The clock count of the change point is set to the average (Rj(j=0)) of the reset inversion clock count by the DAC circuit 70. That is, the clock count of the average (Rj(j=0)) of the reset inversion clock count sets to be equal to the clock count of the change point. The reference pixel signal amount S(0,i) of each column is sequentially stored in the first memory. The reference pixel signal amount S(0,j) may be counted using a ramp signal Vref. Then, the average Sj(j=0) of the reference pixel signal amounts S(0,i) of respective columns in the 0-th row is calculated. For example, when a number of columns is 1024, the sum of S(0,0) to S(0,1023) is divided by 1024 to obtain the average Sj (j=0).

Then, a difference between the calculated average Sj(j=0) of the reference pixel signal amounts S(0,i) and the ideal value SI is calculated as a delay amount Cj(j=0) and stored in the second memory.

The ideal value SI is an ideal reference pixel signal amount calculated on the assumption that no non-linear region is generated, and is calculated as follows. When the average Rj(j=0) of the reset inversion clock counts is 100, the clock count of the change point is set to 100 based on the setting of the change point for the 0-th row (j=0), and the analog gain changes from 1 to ½ at the change point. For example, the DAC circuit may set the clock count of the change point to the calculated average of the reset inversion clock counts (e.g., 100). Accordingly, the slope of the ramp signal Vref after the change point becomes 2 (that is, twice the speed), and the ideal value SI for the first row becomes 100 (=100−0*½).
(2) In the first row (j=1), the value of the reset inversion clock count R(1,i) of each column i is sequentially stored in the first memory. An average Rj(j=1) of the reset inversion clock counts R(1,i) of respective columns in the first row is calculated.

The clock count of the change point is set to a value Rj(j=1)−1 that is obtained by subtracting 1 from the average Rj(j=1) of the reset inversion clock counts R(1,i) by the DAC circuit 70. To test different parts of the transition region, the change point may be adjusted row-by-row by subtracting an increasing value (e.g., Rj-0 for row 0, Rj-1 for row 1, Rj-2 for row 2, etc.). That is, a clock count reduced by 1 from the clock count of the average Rj(j=1) of the reset inversion clock count is used as the clock count of the change point for the first row (j=1). The reference pixel signal amount S(1,i) of each column is sequentially stored in the first memory. Then, the average Sj(j=1) of the reference pixel signal amounts S(1,i) of respective columns in the first row is calculated.

Then, a difference between the calculated average Sj(j=1) of the reference pixel signal amounts S(1,i) and the ideal value SI is calculated as a delay amount Cj(j=1) and stored in the second memory.

The ideal value SI is calculated as follows. When the average Rj(j=1) of the reset inversion clock counts is 100, the clock count of the change point becomes 99 based on the setting of the change point for the first row (j=1), and the analog gain changes from 1 to ½ at the change point. Accordingly, the slope of the ramp signal Vref after the change point becomes 2 (that is, the speed is doubled), and the ideal value SI becomes 99.5 (=100−1*½).
(3) In the second row (j=2), the value of the reset inversion clock count R(2,i) of each column i is sequentially stored in the first memory. An average Rj(j=2) of the reset inversion clock counts R(2,i) of respective columns in the second row is calculated.

The clock count of the change point is set to a value Rj(j=2)−2 that is obtained by subtracting 2 from the average Rj(j=2) of the reset inversion clock counts by the DAC circuit 70. That is, the clock count reduced by 2 from the clock count of the average Rj(j=2) of the reset inversion clocks is set to the clock count of the change point. The reference pixel signal amount S(2,i) of each column is sequentially stored in the first memory. Then, an average Sj(j=2) of the reference pixel signal amounts S(2,i) of respective columns in the second row is calculated.

Then, a difference between the calculated average Sj(j=2) of the reference pixel signal amounts S(2,i) and the ideal value SI is calculated as a delay amount Cj(j=2) and stored in the second memory.

The ideal value SI is calculated as follows. When the average (Rj(j=2)) of the inversion clock counts is 100, the clock count of the change point becomes 98 based on the setting of the change point for the second row (j=2), and the analog gain changes from 1 to ½ at the change point. Thus, the slope of the ramp signal Vref after the change point becomes 2 (that is, the speed is doubled), and the ideal value SI becomes 99 (=100−2*½). (4) In the third row (j=3), the value of the reset inversion clock count R(3,i) of each column i is sequentially stored in the first memory. An average (Rj(j=3)) of the reset inversion clock counts (R(3,i)) of respective columns in the third row is calculated.

The clock count of the change point is set to a value Rj(j=3)−3 that is obtained by subtracting 3 from the average (Rj(j=3)) of the reset inversion clock counts by the DAC circuit 70. That is, the clock count reduced by 3 from the clock count of the average Rj(j=3) of the reset inversion clock counts is used as the clock count of the change point. The reference pixel signal amount S(3,i) of each column is sequentially stored in the first memory. Then, an average Sj(j=3) of the reference pixel signal amounts S(3,i) of respective columns in the third row is calculated.

Then, a difference between the calculated average (Sj(j=3)) of the reference pixel signal amounts S(3,i) and the ideal value SI is calculated as a delay amount Cj(j=3) and stored in the second memory.

The ideal value SI is calculated as follows. When an average (Rj(j=3)) of the reset inversion clock count is 100, the clock count of the change point becomes 97 based on the setting of the change point for the third row (j=3), and the analog gain changes from 1 to ½ at the change point. Accordingly, the slope of the ramp signal Vref after the change point becomes 2 (that is, the speed is doubled), and the ideal value SI becomes 98.5 (=100−3*1/2).
(5) In the fourth row (j=4), the value of the reset inversion clock count R(4,i) of each column i is sequentially stored in the first memory. An average Rj(j=4) of the reset inversion clock counts R(4,i) of respective columns in the fourth row is calculated.

The clock count of the change point is set to a value Rj(j=4)−4 that is obtained by subtracting 4 from the average Rj(j=4) of the reset inversion clock counts by the DAC circuit 70. That is, the clock count reduced by 4 from the clock count of the average Rj(j=4) of the reset inversion clock counts is used as the clock count of the change point. The clock count of the change point is reduced by 4 from the clock count of the average Rj(j=4) of the reset inversion clock counts. The reference pixel signal amount S(4,i) of each column is sequentially stored in the first memory. Then, an average Sj(j=4) of the reference pixel signal amounts S(4,i) of respective columns in the fourth row is calculated.

Then, a difference between the calculated average Sj(j=4) of the reference pixel signal amounts S(4,i) and the ideal value SI is calculated as a delay amount Cj(j=4) and stored in the second memory.

The ideal value SI is calculated as follows. When the average Rj(j=4) of the reset inversion clock counts is 100, the clock count of the change point becomes 96 based on the setting of the change point for the fourth row (j=4), and the analog gain changes from 1 to ½ at the change point. Accordingly, the slope of the ramp signal Vref after the change point becomes 2 (that is, the speed is doubled), and the ideal value SI becomes 98 (=100-4*1/2).
(6) In the m-th row (j=m), the value of the reset inversion clock count R(m,i) of each column i is sequentially stored in the first memory. An average Rj(j=m) of the inversion clock counts R(m,i) of respective columns in the m-th row is calculated.

The clock count of the change point is set to a value Rj(j=m)−m obtained by subtracting m from the average Rj(j=m) of the reset inversion clock count by the DAC circuit 70. That is, the clock count reduced by m from the average Rj(j=m) of the reset inversion clock count is used as the clock count of the change point. The reference pixel signal amount S(m,i) of each column is sequentially stored in the first memory. Then, an average Sj(j=m) of the reference pixel signal amounts S(m,i) of respective columns in the m-th row is calculated.

Then, a difference between the calculated average Sj(j=m) of the reference pixel signal amounts S(m,i) and the ideal value SI is calculated as a delay amount Cj(j=m) and stored in the second memory.

The ideal value SI is calculated as follows. When the average Rj(j=m) of the reset inversion clock counts is 100, the clock count of the change point becomes 100−m based on the setting of the change point for the m-th row (j=m), and the analog gain changes from 1 to ½ at the change point. Accordingly, the slope of the ramp signal Vref after the change point becomes 2 (that is, the speed is doubled), and the ideal value SI becomes 100−m*½.

As illustrated in the example of FIG. 6, in operation S101, the driving control circuit 80 may determine whether a pixel signal amount Y (i.e., a digital pixel value) of each pixel 11 of the pixel array 10 is equal to or greater than a change point setting value P (a change point). In an embodiment, the DAC circuit 70 may generate a ramp signal with the change point setting value P and the pixel signal amount Y is counted using the ramp signal with the change point setting value P. At the change point setting value P, the slope of the ramp signal changes. The change point setting value P corresponds to a number of clocks from a time when the ramp signal is applied to the change point at which the slope change.

When determining that the pixel signal amount Y is less than the change point setting value P (S101: NO), the driving control circuit 80 performs, in operation S102, only a CDS correction operation for the pixel 11 without correcting a non-linear region. For example, when the slope of the ramp signal changes from a first slope to a second slope and the pixel signal is sampled using the first slope, the pixel signal amount Y is less than the change point setting value P. In this case, there is no error due to the non-linear region caused by the slope change.

When determining that the pixel signal amount Y is equal to or greater than the change point setting value P (S101: YES), the driving control circuit 80 determines, in operation S103, whether a value obtained by subtracting the change point setting value P from the pixel signal amount Y is a delay amount C0 or less. In an embodiment, the delay amount C0 may correspond to Cj(j=0) as described with reference to FIG. 5.

When determining that the value obtained by subtracting the change point setting value P from the pixel signal amount Y is the delay amount C0 or less (S103: YES), the driving control circuit 80 calculates, in operation S104, a signal component Vsig after correction that is obtained by correcting the non-linear region according to the following equation.

The signal component Vsig after correction is expressed as: Vsig=(P−R)+((Y−P)−C0)×2.

Here, R denotes the reset component Vrst. In addition, in the present embodiment, multiplying the final term by two corresponds to a process of restoring the analog gain, which is changed from 1 to ½ after the change point, to 1 and maintaining linearity.

When determining that the value obtained by subtracting the change point setting value P from the pixel signal amount Y exceeds the delay amount C0 (S103: NO), the driving control circuit 80 determines, in operation S105, whether the value obtained by subtracting the change point setting value P from the pixel signal amount Y is a delay amount C1 or less.

When determining that the value obtained by subtracting the change point setting value P from the pixel signal amount Y is the delay amount C1 or less (S105: YES), the driving control circuit 80 calculates, in operation S106, a signal component Vsig after correction obtained by correcting the non-linear region according to the following equation.

The signal component Vsig after correction is expressed as: Vsig=(P−R)+((Y−P)−C1)×2.

When determining that the value obtained by subtracting the change point setting value P from the pixel signal amount Y exceeds the delay amount C1 (S105: NO), the driving control circuit 80 determines, in operation S107, whether the value obtained by subtracting the change point setting value P from the pixel signal amount Y is a delay amount C2 or less.

When determining that the value obtained by subtracting the change point setting value P from the pixel signal amount Y is the delay amount C2 or less (S107: YES), the driving control circuit 80 calculates, in operation S108, a signal component Vsig after correction obtained by correcting the non-linear region according to the following equation.

The signal component Vsig after correction is expressed as: Vsig=(P−R)+((Y−P)−C2)×2.

When determining that the value obtained by subtracting the change point setting value P from the pixel signal amount Y exceeds the delay amount C2 (S107: NO), the driving control circuit 80 determines whether the value obtained by subtracting the change point setting value P from the pixel signal amount Y is a delay amount C3 or less.

Likewise, comparison between the value obtained by subtracting the change point setting value P from the pixel signal amount Y and a delay amount C and calculation of the signal component Vsig after correction that is obtained by correcting the non-linear region are performed until calculation related to a delay amount Cm is completed.

Specifically, in operation S109, the driving control circuit 80 determines whether the value obtained by subtracting the change point setting value P from the pixel signal amount Y is a delay amount Cm−1 or less.

When determining that the value obtained by subtracting the change point setting value P from the pixel signal amount Y is the delay amount Cm−1 or less (S109: YES), the driving control circuit 80 calculates, in operation S110, a signal component Vsig after correction that is obtained by correcting the non-linear region according to the following equation.

The signal component Vsig after correction is expressed as: Vsig=(P−R)+((Y−P)−Cm−1)×2.

When determining that the value obtained by subtracting the change point setting value P from the pixel signal amount Y exceeds a delay amount Cm−1 (S109: NO), the driving control circuit 80 determines, in operation S111, whether the value obtained by subtracting the change point setting value P from the pixel signal amount Y is greater than the delay amount Cm.

When determining that the value obtained by subtracting the change point setting value P from the pixel signal amount Y is greater than the delay amount Cm (S111: YES), the driving control circuit 80 calculates, in operation S112, the signal component Vsig after correction that is obtained by correcting the non-linear region according to the following equation.

The signal component Vsig after correction is expressed as: Vsig=(P−R)+((Y−P)−Cm)×2.

By performing the process according to the sequence illustrated in FIG. 6 for all pixels 11 of the pixel array 10, non-linear regions of the signal components Vsig of all pixels 11 may be corrected.

In the example illustrated in FIG. 5, a value that is the reset inversion clock count R or less is set as the change point, wherein the reset inversion clock count R is detected from the reference pixel 91. For example, in FIG. 5, to test different parts of the transition region, the change point is adjusted row-by-by by subtracting an increasing value (e.g., Rj−0 for row 0, Rj−1 for row 1, Rj−2 for row 2, etc.). However, the present disclosure is not limited thereto. In an embodiment, a value equal to or greater than the reset inversion clock R detected from the reference pixel 91 may be set as the change point. In the description above, the signal component Vsig after correction may include a first part of (P−R) and a second part of ((Y−P)−C)*2. The first part corresponds to (P−R). In the CDS operation, the reset component R is subtracted from the read data component (Vrst+Vsig) to isolate the true signal. The first part of (P−R) corresponds to the signal amount captured at the original, initial slope A before the slope of the ramp signal changes to the slope B as shown in FIG. 3, for example. The second part of ((Y−P)−C)*2) corresponds to the signal amount captured at the fast slope of the slope B. The delay amount C is subtracted to correct the non-linear region. The number 2 is multiplied to restore the gain of the ramp signal. In other words, the number 2 is multiplied such that the second part has the same mathematical weight as that of the first part. The number 2 may be referred to as a gain restoration factor, which is the inverse of the analog gain of the ramp signal.

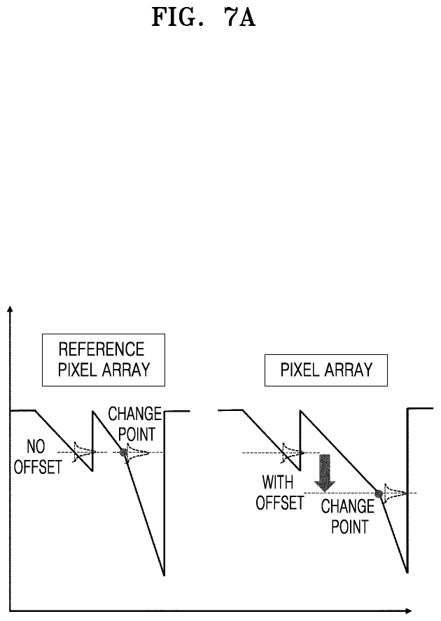

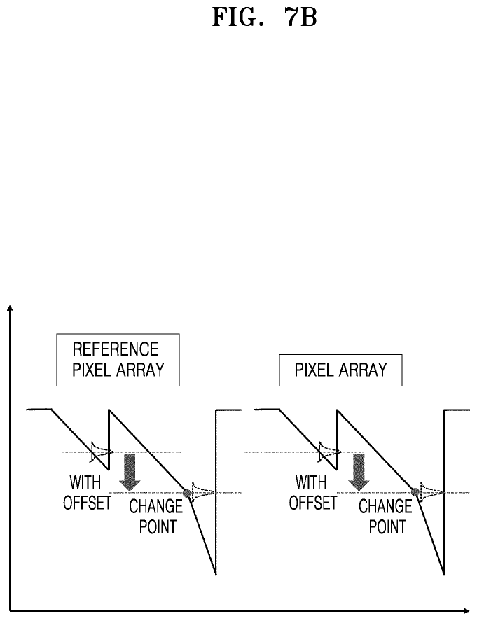

FIG. 7A illustrates a ramp signal Vref when a value that is substantially the same as the reset inversion clock count R detected from each reference pixel 91 of the reference pixel array 90 is set as a change point. FIG. 7B illustrates a ramp signal Vref when a value that is greater than the reset inversion clock count R detected from each reference pixel 91 of the reference pixel array 90 is set as a change point.

As shown on the left side of FIG. 7B, a value that is greater than the reset inversion clock count R detected from each reference pixel 91 of the reference pixel array 90 may be set as the change point. In this case, as shown on the right side of FIG. 7B, even when the pixel signal of each pixel 11 of the pixel array 10 is AD-converted by the ADC circuit 25, the ramp signal Vref, of which the analog gain is changed at the set change point, may be used.

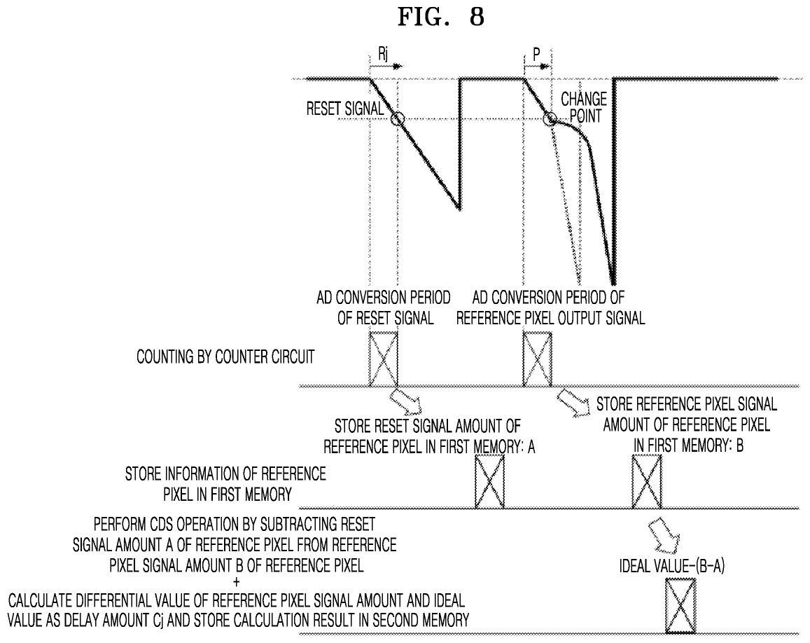

FIG. 8 is a timing diagram showing a timing at which information regarding the reference pixel 91 of the reference pixel array 90 is stored in the memory 40.

The reset signal (the reset component Vrst) of the reference pixel 91 is AD-converted by being counted by the counter circuit 30, and a reset signal amount of the reference pixel 91 obtained by the AD conversion is stored in the first memory.

Then, a reference pixel signal of the reference pixel 91 is AD-converted by being counted by the counter circuit 30, and a reference pixel signal amount of the reference pixel 91 obtained by the AD conversion is stored in the first memory.

Then, a CDS operation is performed by obtaining a difference between the reset signal amount of the reference pixel 91 in a specific row that is stored in the first memory and the reference pixel signal amount of the reference pixel 91 in a specific row that is stored in the first memory.

Furthermore, the difference between the reference pixel signal amount and an ideal straight line (corresponding to the slope B shown in FIG. 3) is calculated as a delay amount Cj, and a calculation result is stored in the second memory.

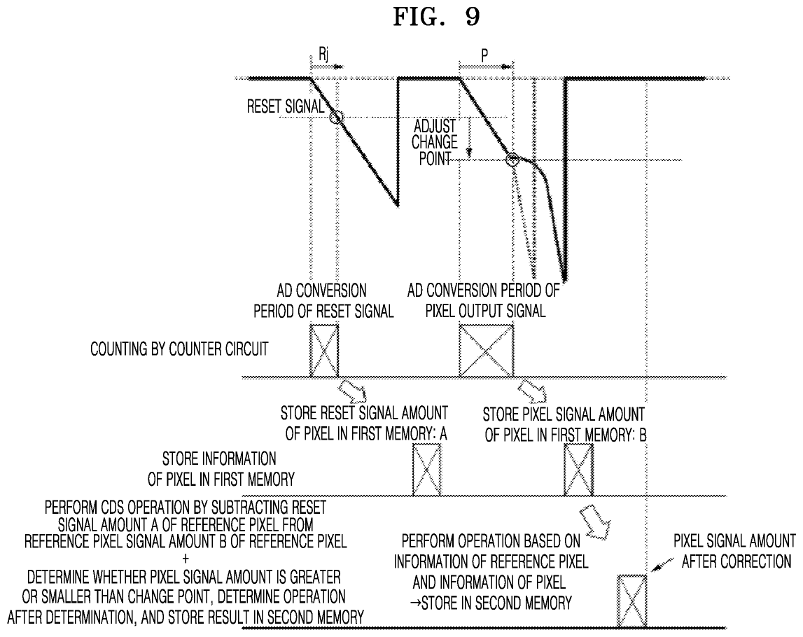

FIG. 9 is a timing diagram showing a timing at which information regarding a pixel 11 of the pixel array 10 is stored in the memory 40.

The reset signal of the pixel 11 is AD-converted by being counted by the counter circuit 30, and a reset signal amount of the pixel 11 obtained by the AD conversion is stored in the first memory.

Then, a pixel signal of the pixel 11 is AD-converted by being counted by the counter circuit 30, and a pixel signal amount of the pixel 11 obtained by the AD conversion is stored in the first memory.

Then, a pixel signal amount after correction (the signal component Vsig), in which the non-linear region is corrected, is calculated using information regarding the reference pixel 91 and the information regarding the pixel 11, and a calculation result is stored in the second memory. Specifically, by comparing whether a pixel signal amount is greater or smaller than a change point, a delay amount Cj to be used for calculation (i.e., correction) is determined from among the delay amounts Cj calculated using the reference pixel 91 according to the difference between the pixel signal amount and the change point. Then, both correction of the non-linear region and a CDS correction operation are performed using the determined delay amount Cj. The above process is provided in detail in the above description of FIG. 6.

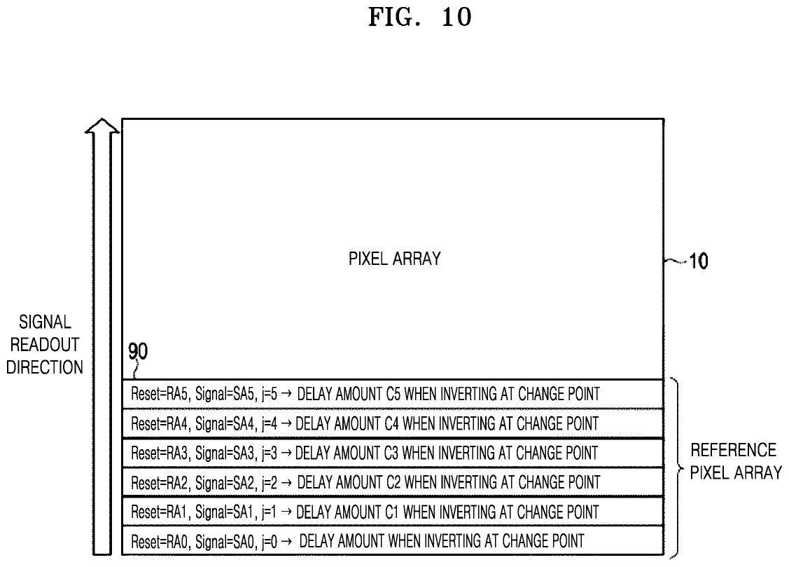

FIG. 10 illustrates assignment of a change point and a calculated delay amount Cj to each row of a reference pixel array when a delay amount Cj is calculated for each row by using the reference pixel array 90.

For example, the 0-th row (j=0) of the reference pixel array 90, which is farthest from the pixel array 10, is assigned as a row for setting a change point to an average RA0 of the reset inversion clock counts R of respective columns, calculating an average SA0 of reference pixel signal amounts S of the respective columns, and calculating a difference from the ideal value SI as a delay amount C0.

For example, the first row (j=1) of the reference pixel array 90 is assigned as a row for setting a change point to a clock count obtained by subtracting 1 from an average RA1 of the reset inversion clock counts R of respective columns, calculating an average SA1 of the reference pixel signal amounts S of the respective columns, and calculating a difference from the ideal value SI as a delay amount C1.

For example, the second row (j=2) of the reference pixel array 90 is assigned as a row for setting a change point to a clock count obtained by subtracting 2 from an average RA2 of the reset inversion clock counts R of respective columns, calculating an average SA2 of the reference pixel signal amounts S of the respective columns, and calculating a difference from the ideal value SI as a delay amount C2.

For example, the third row (j=3) of the reference pixel array 90 is assigned as a row for setting a change point to a clock count obtained by subtracting 3 from an average RA3 of the reset inversion clock counts R of respective columns, calculating an average SA3 of the reference pixel signal amounts S of the respective columns, and calculating a difference from the ideal value SI as a delay amount C3.

For example, the fourth row (j=4) of the reference pixel array 90 is assigned as a row for setting a change point to a clock count obtained by subtracting 4 from an average RA4 of the reset inversion clock counts R of respective columns, calculating an average SA4 of the reference pixel signal amounts S of the respective columns, and calculating a difference from the ideal value SI as a delay amount C4.

For example, the fifth row (j=5) of the reference pixel array 90 is assigned as a row for setting a change point to a clock count obtained by subtracting 5 from an average RA5 of the reset inversion clock counts R of respective columns, calculating an average SA5 of the reference pixel signal amounts S of the respective columns, and calculating a difference from the ideal value SI as a delay amount C5.

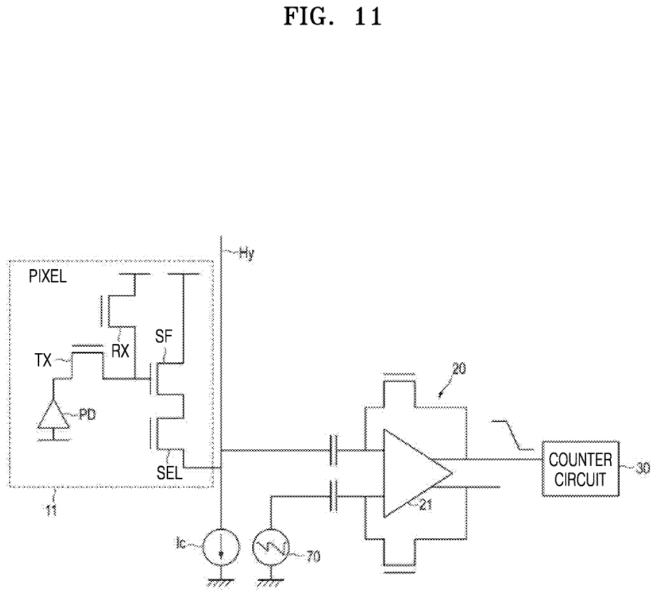

FIG. 11 illustrates an example of a circuit configuration of the comparison unit 20.

In the example illustrated in FIG. 11, the comparison unit 20 compares a pixel signal output from the pixel 11 with a ramp signal Vref generated by the DAC circuit 70 by using an operational amplifier 21, and outputs a comparison result to the counter circuit 30. The comparison unit 20 may include a capacitor for DC blocking and a MOS transistor for initialization. The comparison unit 20 may also include a current source Ic for driving a source follower transistor SF of each pixel 11.

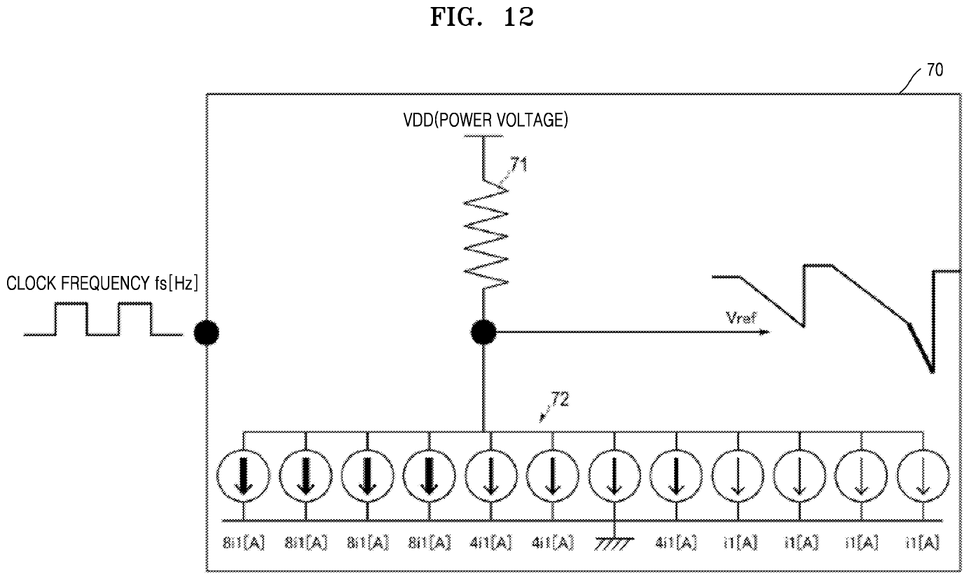

FIG. 12 illustrates an example of a ramp circuit configuration of a DAC circuit 70.

In the example illustrated in FIG. 12, the DAC circuit 70 may include a resistor 71 and a plurality of current sources 72. A current value of each current source 72 may be one of a reference current value i1 and an arbitrary integral multiple of the reference current value i1. Each current source 72 may be controlled to be driven or not driven in synchronization with the clock frequency fs to generate the ramp signal Vref. The reference current value i1 may be determined as an appropriate value by considering a relationship between a value of the resistor 71 and an input level allowable in the circuit of the comparison unit 20. For example, the current value of each current source 72 may be i1, 4i1 (i.e., 4 times i1), or 8i1 (i.e., 8 times i1). The current source 72 may be configured by, for example, a plurality of MOS transistors having different gate widths, and the driving or non-driving of each current source 72 may be controlled by application or non-application of a gate voltage input to the MOS transistors.

By controlling the plurality of current sources 72 having different current values, the ramp signal Vref is generated. FIG. 12 illustrates that a portion of the ramp signal Vref indicated by a thick line represents the ramp signal Vref after the slope has changed via the change point.

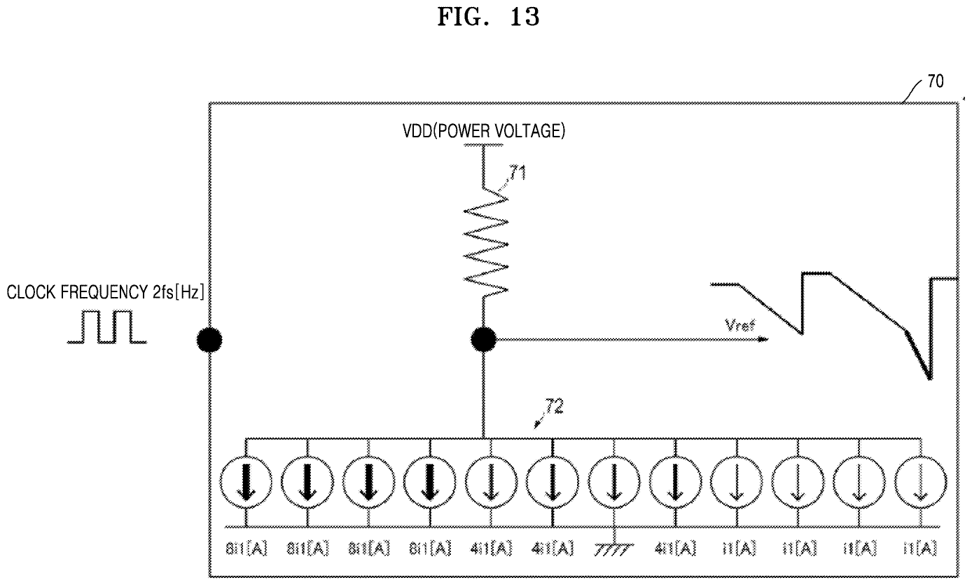

FIG. 13 illustrates another example of a ramp circuit configuration of the DAC circuit 70.

In the example illustrated in FIG. 13, the DAC circuit 70 may include a resistor 71 and a plurality of current sources 72. A current value of each current source 72 may be one of a reference current value i1 and an arbitrary integral multiple of the reference current value i1. Each current source 72 may be controlled to be driven or not driven in synchronization with the clock frequency fs to generate the ramp signal Vref. The reference current value i1 may be determined as an appropriate value by considering a relationship between a value of the resistor 71 and an input level allowable in the circuit of the comparison unit 20. For example, the current value of each current source 72 may be i1, 4i1, or 8i1. The current source 72 may be configured by, for example, a plurality of MOS transistors having different gate widths, and the driving or non-driving of each current source 72 may be controlled by application or non-application of a gate voltage input to the MOS transistors.

By controlling the plurality of current sources 72 having different current values, the ramp signals Vref are generated. A portion of the ramp signal Vref indicated by a thick line represents the ramp signal Vref after a slope has changed via a change point. In the example illustrated in FIG. 13, the slope of the ramp signal Vref is changed by doubling the clock frequency. FIGS. 12 and 13 illustrate the two ways the DAC circuit 70 changes the slope of the ramp signal Vref. In FIG. 12, the slope is changed by controlling a plurality of current sources 72 with different values (e.g., i1, 4i1, or 8i). By switching which current sources are driven at the change point, the voltage step per clock cycle increases, thereby steepening the slope. In FIG. 13, the slope is changed by doubling the clock frequency (fs). By increasing the frequency at which the DAC steps through the voltage, the ramp signal reaches its target level faster.

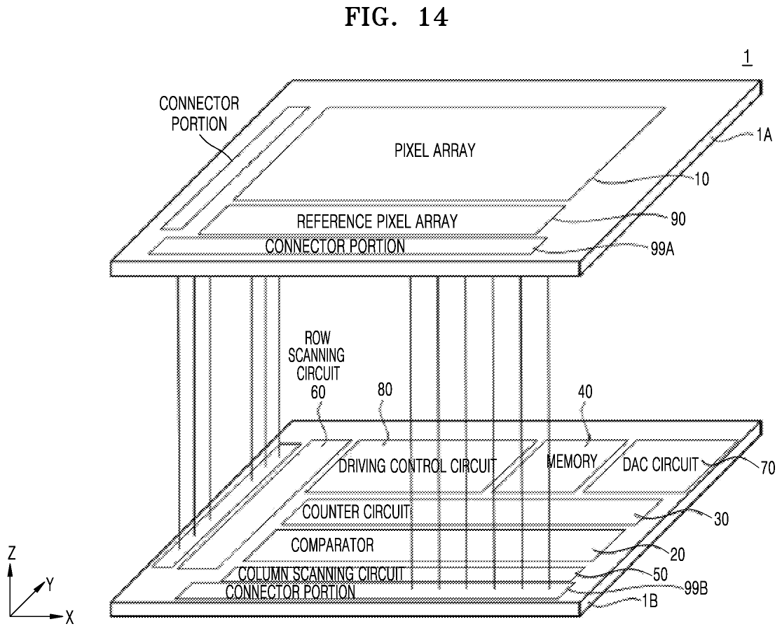

FIG. 14 illustrates a stack structure of a solid-state imaging device 1.

In the example illustrated in FIG. 14, the solid-state imaging device 1 has a two-layer structure in which two chips, that is, a pixel chip 1A and a logic chip 1B, are stacked. On the pixel chip 1A, a pixel array 10, a reference pixel array 90, and a connector portion 99A may be mounted. On the logic chip 1B, a comparison unit 20, a counter circuit 30, a memory 40, a column scanning circuit 50, a row scanning circuit 60, a DAC circuit 70, a driving control circuit 80, and a connector portion 99B may be mounted. The connector portions 99A and 99B may each include pads, bumps, or the like for electrically connecting wiring of the pixel chip 1A to that of the logic chip 1B.

Hereinafter, the second embodiment is described. The differences between the present embodiment and the first embodiment are as follows. In the first embodiment, a constant delay amount Cj is calculated for each row of the reference pixel array 90, and for pixels 11 in the same row of the pixel array 10, the non-linear region is corrected based on the same delay amount Cj to detect a pixel signal amount. Meanwhile, in the present embodiment, a delay amount Cj is calculated for each row or column of the reference pixel array 90, and the non-linear region is corrected based on an appropriate delay amount Cj for each pixel 11 of the pixel array 10, thereby detecting a pixel signal amount. Other configurations of the present embodiment are the same as those of the first embodiment, and thus, repeated descriptions are omitted or simplified.

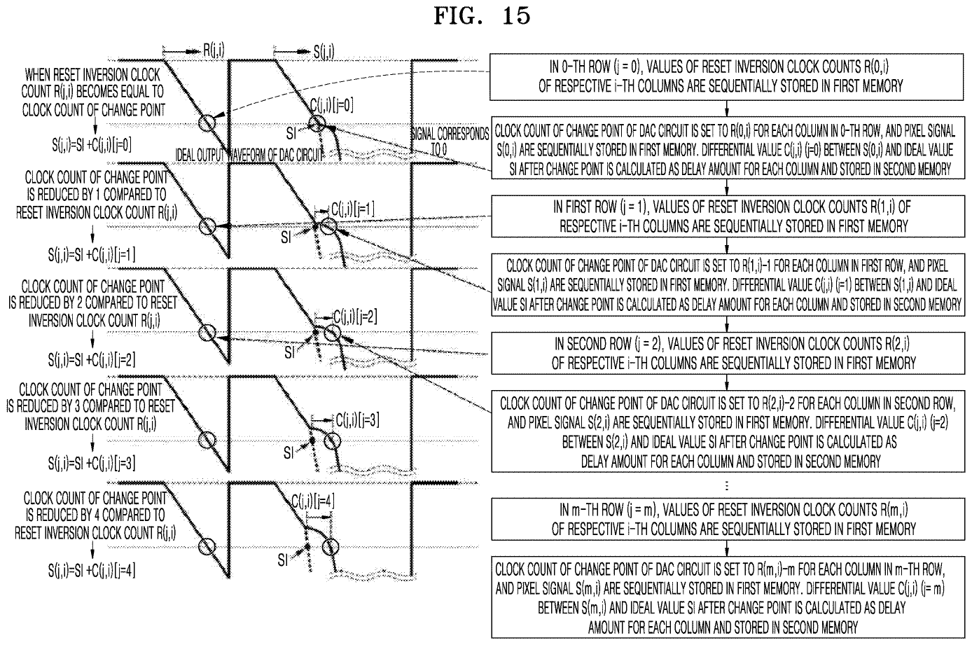

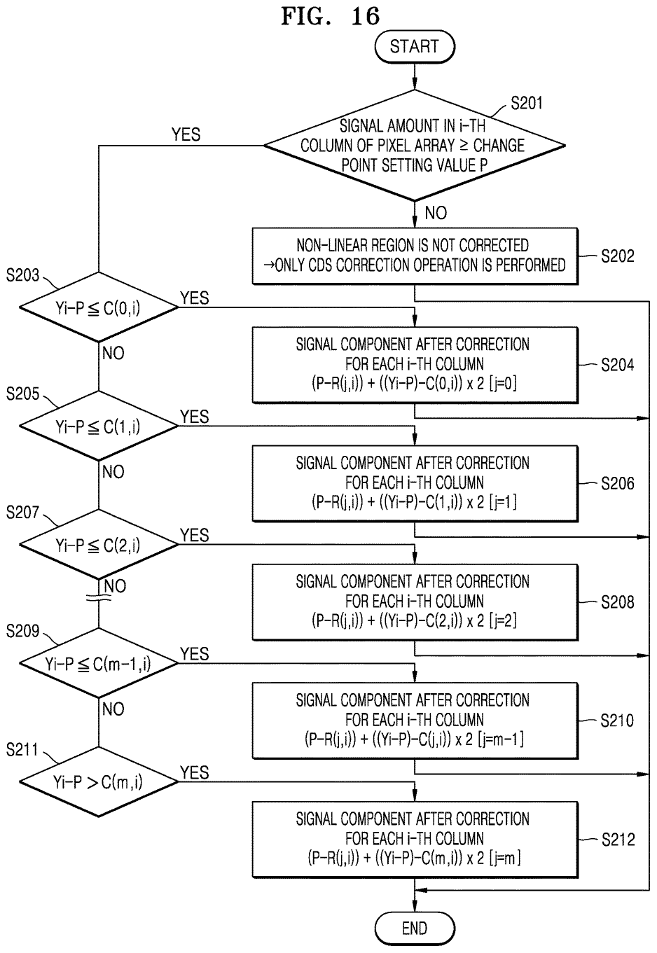

FIG. 15 illustrates a sequence for calculating a delay amount C(j,i) for each row and each column by using reference pixel signals of the reference pixel array 90. Here, i denotes a column number. FIG. 16 illustrates a sequence for correcting a pixel signal of the pixel array 10 with a calculated delay amount C(j,i).

As illustrated in the example of FIG. 15, the delay amount C(j,i) is calculated as a difference between the reference pixel signal amount S(j,i) and the ideal value SI of the ramp signal Vref having a changed slope. The delay amount C(j,i) is calculated for each difference by varying the difference between the reference pixel signal amount S(j,i) and the change point. Specifically, the following operations (1) to (6) are performed.

The ideal value SI is an ideal reference pixel signal amount calculated on the assumption that no non-linear region is generated, and is calculated, for example, as follows. When a reset inversion clock count R(j,i) is 100 and j is equal to 4, the clock count of the change point becomes 96 based on a setting of the change point for the fourth row (j=4) described below, and the analog gain changes from 1 to ½ at the change point. Accordingly, the slope of the ramp signal Vref after the change point becomes 2 (that is, the speed is doubled), and the ideal value SI becomes 98 (=100 4*½).
(1) In the 0-th row (j=0), the value of the reset inversion clock count R(0,i) of each column i is sequentially stored in the first memory.

The clock count of the change point is set to the reset inversion clock count R(0,i) for each column i by the DAC circuit 70. That is, the reference pixel signal amount S(0,i) for each column is sequentially stored in the first memory by making the reset inversion clock count R(0,i) of each column i identical to the clock count of the change point.

For each column i, a difference between the calculated reference pixel signal amount S(0,i) and the ideal value SI is calculated as a delay amount C(0,i) and stored in the second memory.
(2) In the first row (j=1), the value of the reset inversion clock count R(1,i) of each column i is sequentially stored in the first memory.

The clock count of the change point is set to R(1,i)−1 for each column i by the DAC circuit 70. In other words, the clock count reduced by 1 from the reset inversion clock count R(1,i) for each column i is set as the clock count of the change point. The reference pixel signal amount S(1,i) of each column i is sequentially stored in the first memory. The reference pixel signal amount S(1,i) of each column i in the first row is calculated.

For each column i, a difference between the calculated reference pixel signal amount S(1,i) and the ideal value SI is calculated as a delay amount C(1,i) and stored in the second memory.
(3) In the second row (j=2), the value of the reset inversion clock count R(2,i) of each column i is sequentially stored in the first memory.

The clock count of the change point is set to R(2,i)−2 for each column i by the DAC circuit 70. In other words, the clock count reduced by 2 from the reset inversion clock count R(2,i) for each column i is set as the clock count of the change point. The reference pixel signal amount S(2,i) of each column i is sequentially stored in the first memory.

For each column i, a difference between the calculated reference pixel signal amount S(2,i) and the ideal value SI is calculated as a delay amount C(2,i) and stored in the second memory.
(4) In the third row (j=3), the value of the reset inversion clock count R(3,i) of each column i is sequentially stored in the first memory.

The clock count of the change point is set to R(3,i)−3 for each column i by the DAC circuit 70. In other words, the clock count reduced by 3 from the reset inversion clock count R(3,i) for each column i is set as the clock count of the change point. The reference pixel signal amount S(3,i) of each column i is sequentially stored in the first memory.

For each column i, a difference between the calculated reference pixel signal amount S(3,i) and the ideal value SI is calculated as a delay amount C(3,i) and stored in the second memory.
(5) In the fourth row (j=4), the value of the reset inversion clock count R(4,i) of each column i is sequentially stored in the first memory.

The clock count of the change point is set to R(4,i)-4 for each column i by the DAC circuit 70. In other words, the clock count reduced by 4 from the reset inversion clock count R(4,i) for each column i is set as the clock count of the change point. The reference pixel signal amount S(4,i) of each column i is sequentially stored in the first memory.

For each column, a difference between the calculated reference pixel signal amount S(4,i) and the ideal value SI is calculated as a delay amount C(4,i) and stored in the second memory.
(6) In the m-th row (j=m), the value of the reset inversion clock count R(m,i) of each column i is sequentially stored in the first memory.

The clock count of the change point is set as R(m,i)−m for each column i by the DAC circuit 70. In other words, the clock count reduced by m from the reset inversion clock count R(m,i) for each column i is set as the clock count of the change point. The reference pixel signal amount S(m,i) of each column i is sequentially stored in the first memory.

For each column, a difference between the calculated reference pixel signal amount S(m,i) and the ideal value SI is calculated as a delay amount C(m,i) and stored in the second memory.

As illustrated in the example of FIG. 16, in operation S201, the driving control circuit 80 determines whether a pixel signal amount Yi of each pixel 11 of the pixel array 10 in an i-th column is equal to or greater than a change point setting value P (a change point).

When determining that the pixel signal amount Yi is less than the change point setting value P (S201: NO), the driving control circuit 80 does not perform correction for the non-linear region for the pixel 11 and performs only a CDS correction operation, in operation S202.

When determining that the pixel signal amount Yi is equal to or greater than the change point setting value P (S201: YES), the driving control circuit 80 determines, in operation S203, whether the value obtained by subtracting the change point setting value P from the pixel signal amount Yi is a delay amount C(0,i) or less.

When determining that the value obtained by subtracting the change point setting value P from the pixel signal amount Yi is the delay amount C(0,i) or less (S203: YES), the driving control circuit 80 calculates, in operation S204, a signal component Vsig after correction that is obtained by correcting the non-linear region according to the following equation.

The signal component Vsig after correction is expressed as: Vsig=(P−R(j,i))+((Yi−P)−C(0,i))×2, where j=0.

Here, R denotes a reset level corresponding to a reset component Vrst. In addition, in the present embodiment, multiplying the final term by two corresponds to a process of restoring the analog gain, which is changed from 1 to ½ after the change point, to 1 and maintaining linearity.

When determining that the value obtained by subtracting the change point setting value P from the pixel signal amount Yi exceeds the delay amount C(0,i) (S203: NO), the driving control circuit 80 determines, in operation S205, whether the value obtained by subtracting the change point setting value P from the pixel signal amount Yi is a delay amount C(1,i) or less.

When determining that the value obtained by subtracting the change point setting value P from the pixel signal amount Yi is the delay amount C(1,i) or less (S205: YES), the driving control circuit 80 calculates, in operation S206, a signal component Vsig after correction that is obtained by correcting the non-linear region according to the following equation.

The signal component Vsig after correction is expressed as: Vsig=(P−R(j,i))+((Yi−P)−C(1,i))×2, where j=1.

When determining that the value obtained by subtracting the change point setting value P from the pixel signal amount Yi exceeds the delay amount C(1,i) (S205: NO), the driving control circuit 80 determines, in operation S207, whether the value obtained by subtracting the change point setting value P from the pixel signal amount Yi is a delay amount C(2,i) or less.

When determining that the value obtained by subtracting the change point setting value P from the pixel signal amount Yi is the delay amount C(2,i) or less (S207: YES), the driving control circuit 80 calculates, in operation S208, a signal component Vsig after correction that is obtained by correcting the non-linear region according to the following equation.

The signal component Vsig after correction is expressed as: Vsig=(P-R(j,i))+((Yi−P)−C(2,i))×2, where j=2.

When determining that the value obtained by subtracting the change point setting value P from the pixel signal amount Yi exceeds the delay amount C(2,i) (S207: NO), the driving control circuit 80 determines whether the value obtained by subtracting the change point setting value P from the pixel signal amount Yi is a delay amount C(3,i) or less.

Likewise, comparison between the value obtained by subtracting the change point setting value P from the pixel signal amount Yi and the delay amount C(m,i) and calculation of the signal component Vsig after correction that is obtained by correcting the non-linear region are performed until calculation related to the delay amount C(m,i) for all pixels 11 is completed.

Specifically, in operation S209, the driving control circuit 80 determines whether the value obtained by subtracting the change point setting value P from the pixel signal amount Yi is a delay amount C(m−1,i) or less.

When determining that the value obtained by subtracting the change point setting value P from the pixel signal amount Yi is the delay amount C(m−1,i) or less (S209: YES), the driving control circuit 80 calculates, in operation S210, a signal component Vsig after correction that is obtained by correcting the non-linear region according to the following equation.

The signal component Vsig after correction is expressed as: Vsig=(P−R(j,i))+((Yi−P)−C(m−1,i))×2, wherein j=m−1.

When determining that the value obtained by subtracting the change point setting value P from the pixel signal amount Y exceeds the delay amount C (m−1,i) (S209: NO), the driving control circuit 80 determines, in operation S211, whether the value obtained by subtracting the change point setting value P from the pixel signal amount Yi is greater than the delay amount C(m,i).

When determining that the value obtained by subtracting the change point setting value P from the pixel signal amount Yi is greater than the delay amount C(m,i) (S211: YES), the driving control circuit 80 calculates, in operation S212, a signal component Vsig after correction that is obtained by correcting the non-linear region according to the following equation.

The signal component Vsig after correction is expressed as: Vsig=(P−R(j,i))+((Yi−P)−C(m,i))×2, where j=m.

By performing the process according to the flow illustrated in FIG. 16 for all pixels 11 of the pixel array 10, non-linear regions of the signal components Vsig of all pixels 11 are corrected.

In the example illustrated in FIG. 15, a value that is the reset inversion clock R or less detected from the reference pixel 91 is set as the change point. However, the value that is greater than the reset inversion clock R detected from the reference pixel 91 may be set as the change point.

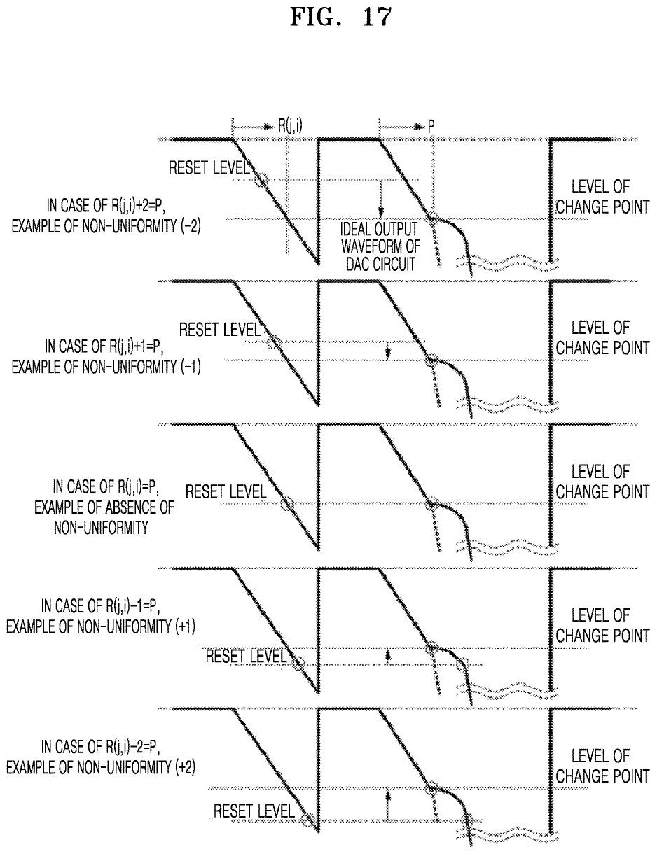

FIG. 17 is a diagram for explaining an effect by non-uniformity among columns in a reset level R(j,i) of reference pixels 91 in the same row.

FIG. 17 illustrates an effect on the change point in a case where the reset level R(j,i) converted into a count value (a clock count) after AD conversion performed by the counter circuit 30 is non-uniform within a range from −2 to +2. The non-uniformity of the reset level R(j,i) may be caused by an effect of signal delay occurring due to parasitic capacitance of wiring of the ramp signal Vref from the DAC circuit 70 to inputs of the comparison unit 20 in respective columns, or the like.

When a setting value of the reset level R(j,i) does not match an actual change point of the ramp signal Vref, it is not preferable because such mismatch affects the measurement accuracy of the delay amount C after the analog gain is changed.

However, according to the flow of FIG. 15 in which correction is performed by using the delay amount C(j,i), the influence of mismatch in the actual change point of the ramp signal Vref may be suppressed. For example, when there is a difference of several clock counts (e.g., five clock counts) between the delay amount C(j,i) and the delay amount C(j+1,i) and when the non-uniformity of the reset level R falls within the above range, a signal component of the pixel signal amount after correction of the non-linear region becomes the same value, and thus, the influence of the non-uniformity of the reset level R may be suppressed.

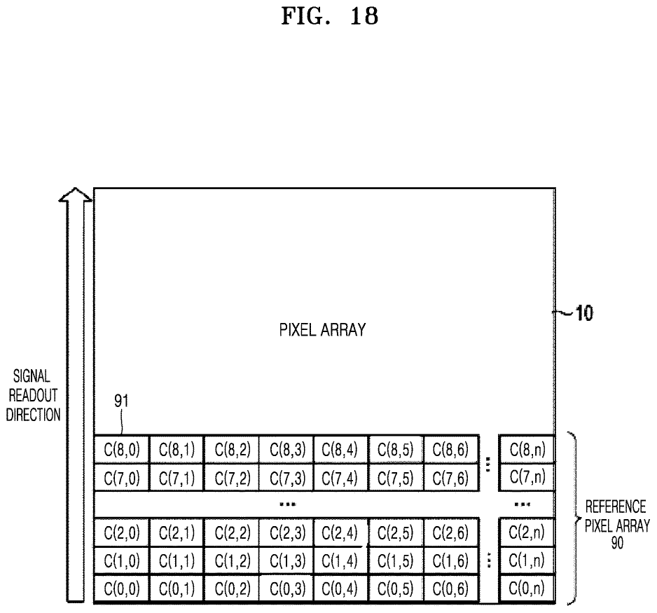

FIG. 18 illustrates assignment of a change point and a calculated delay amount C(j,i) to each reference pixel 91 of a reference pixel array 90 when a delay amount C(j,i) is calculated for each reference pixel 91 by using the reference pixel array 90.

For example, each of reference pixels 91 in the 0-th row (j=0) of the reference pixel array 90, which is farthest from the pixel array 10, is assigned as a reference pixel 91 in a row for setting a change point to the reset inversion clock count R(0,i), calculating a reference pixel signal amount S(0,i) of each column, and calculating a difference from the ideal value SI as a delay amount C(0,i).

For example, each of reference pixels 91 in the first row (j=1) of the reference pixel array 90 is assigned as a reference pixel 91 in a row for setting a change point to a clock count obtained by subtracting 1 from the reset inversion clock counts R(1,i), calculating the reference pixel signal amount S(1,i) of each column, and calculating a difference from the ideal value SI as a delay amount C(1,i).

For example, each of reference pixels 91 in the second row (j=2) of the reference pixel array 90 is assigned as a reference pixel 91 in a row for setting a change point to a clock count obtained by subtracting 2 from the reset inversion clock counts R(2,i), calculating the reference pixel signal amount S(2,i) of each column, and calculating a difference from the ideal value SI as a delay amount C(2,i).

Hereinafter, in a similar manner, reference pixels 91 in a row from the third row onward are assigned as reference pixels 91 in a row for calculating a delay amount C for each column.

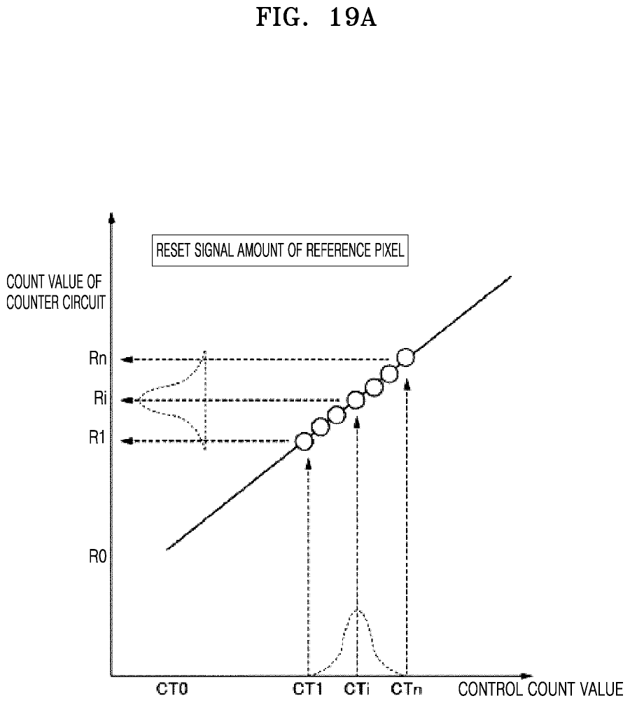

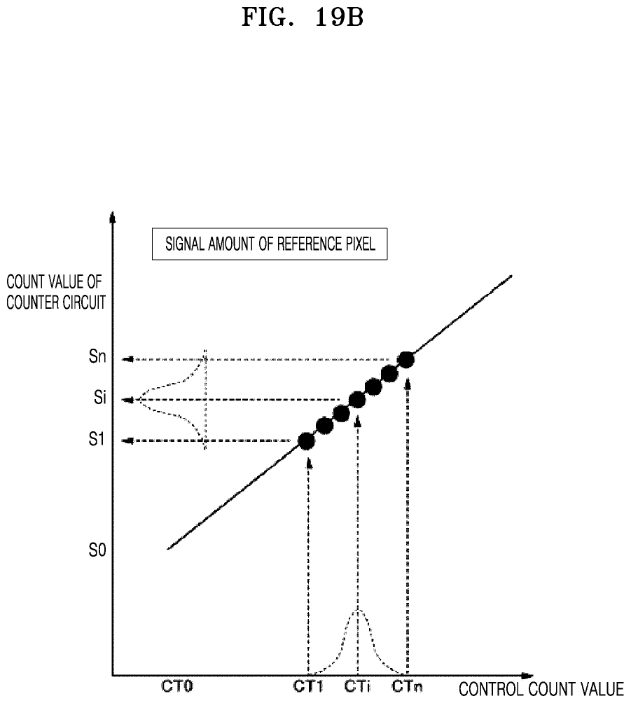

FIG. 19A illustrates a relationship (distribution) between a reset signal amount (a count value Ri of the counter circuit 30) of the reference pixel 91 and a control count CTi when a reference pixel signal amount is less than a change point. FIG. 19B illustrates a relationship (distribution) between a pixel signal amount (a count value Si of the counter circuit 30) of the reference pixel 91 and a control count CTi when a reference pixel signal amount is less than a change point. The control count CTi corresponds to an accumulated count of clocks generated by the driving control circuit 80.

As illustrated in FIGS. 19A and 19B, when the reference pixel signal amount is less than the change point, the reset signal amount and the pixel signal amount of a pixel 11 are non-uniform in a row direction (non-uniform among columns), but are proportional to a control count. Thus, there is no need to correct the non-linear region. A case where the pixel signal amount is less than the change point may correspond to a case where the pixel signal does not reach the change point.

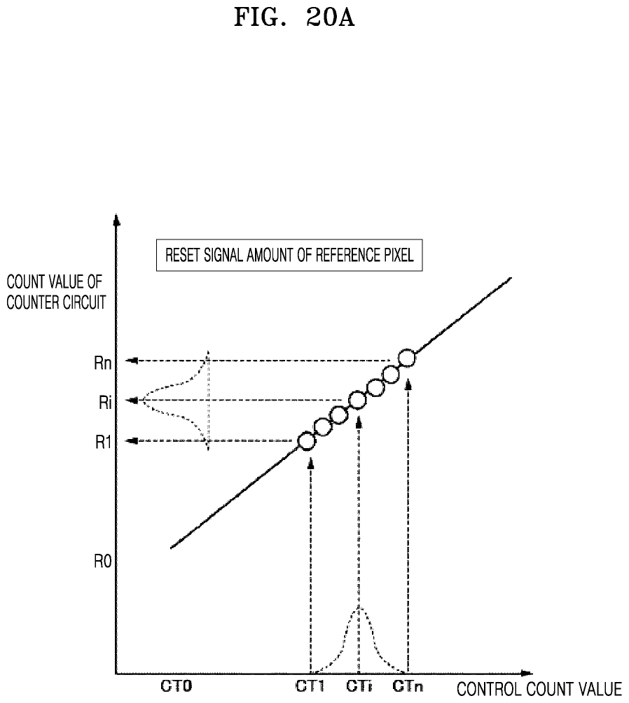

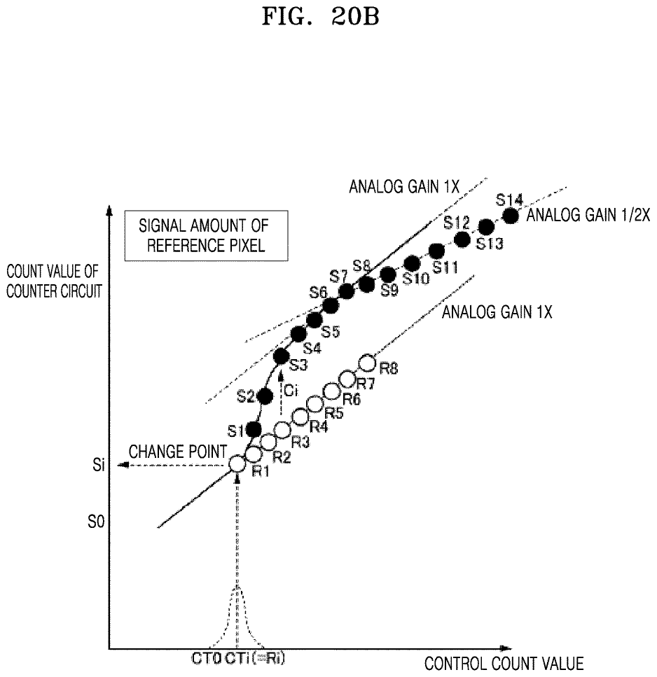

FIG. 20A illustrates a relationship (distribution) between a reset signal amount (a count value Ri of the counter circuit 30) of the reference pixel 91 and a control count CTi when a reference pixel signal amount is equal to or greater than a change point. FIG. 20B illustrates a relationship (distribution) between a pixel signal amount (a count value Si of the counter circuit 30) of the pixel 11 and a control count CTi when a reference pixel signal amount is equal to or greater than a change point.

As illustrated in FIGS. 20A and 20B, when the reference pixel signal amount is equal to or greater than a change point, the accuracy of the reference pixel signal amount detected as a count value by the counter circuit 30 may be degraded because of an influence of a non-linear region generated by delay resulting from parasitic capacitance of wiring or the like. In addition, because the reset signal amount of the reference pixel 91 is non-uniform in each column, the accuracy of the reference pixel signal amount may be further degraded. As described above, because the ramp signal Vref is transmitted to the comparison units 20 arranged in the row direction, the non-linear region may occur due to a delay caused by the parasitic capacitance of wiring or the like. This may degrade the detection accuracy of the pixel signal amount. Therefore, as in the present embodiment, it is preferable to determine the position of the change point for each column and calculate the delay amount C for each column.

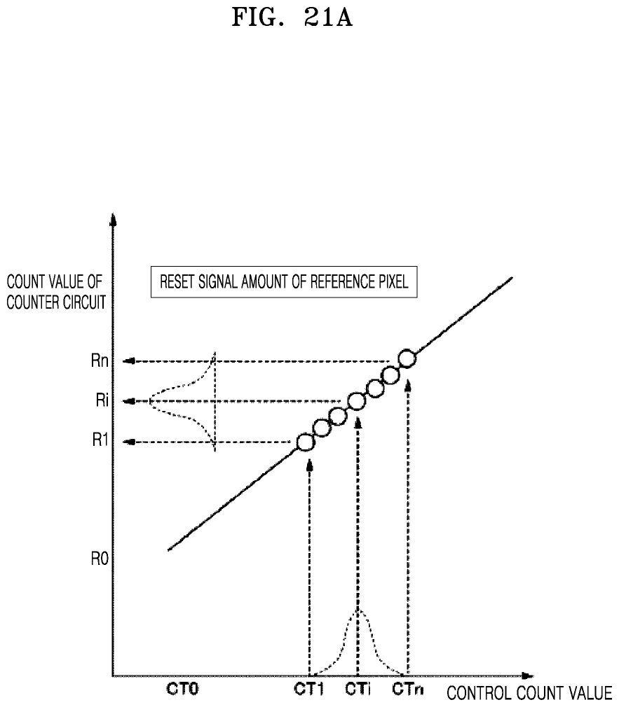

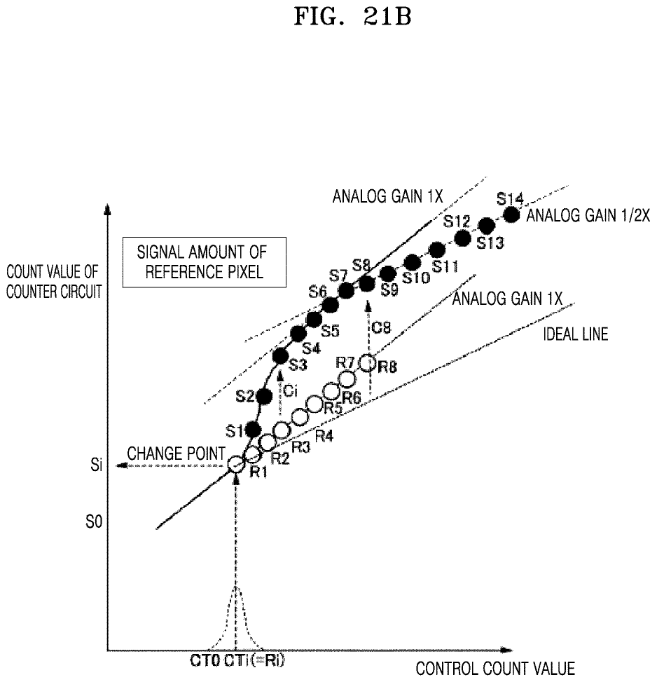

Referring to FIG. 20B, count values S1 to S8 (see FIG. 21B) obtained by the counter circuit 30, which correspond to reference pixel signal amounts of the ramp signal Vref in the non-linear region corresponding to reference reset signal amounts R1 to R8 of the reference pixels, correspond to count values after the change point, but the count values S1 to S8 are count values in a region that does not converge to ½ that is an analog gain after the change point. Count values S9 to S14 obtained by the counter circuit 30 may be count values in a region that converges to ½ that is an analog gain after the change point. For example, FIGS. 20A and 20B show the degradation of accuracy when a pixel signal amount reaches or exceeds the change point.

FIG. 21A illustrates a relationship (distribution) between a reset signal amount (a count value Ri of the counter circuit 30) of the reference pixel 91 and a control count CTi when a reference pixel signal amount is equal to or greater than a change point. FIG. 21B illustrates a relationship (distribution) between a pixel signal amount (a count value Si of the counter circuit 30) of the pixel 11 and a control count CTi when a reference pixel signal amount is equal to or greater than a change point.

In FIG. 21B, the count values S9 to S14 obtained by the counter circuit 30 may be count values in a region that converges to 1/2 that is an analog gain after the change point. Therefore, the delay amount in this region may be set to a constant value (e.g., a delay amount uniformly corresponding to the count value S8). The count values S1 to S8 obtained by the counter circuit 30, which correspond to the reference pixel signal amounts of the ramp signals Vref in the non-linear region corresponding to the reset signal amounts R1 to R8 of the reference pixels, are count values in a region that does not converge to ½ that is an analog gain after change point. Therefore, it is advantageous to correct the non-linear region by calculating the delay amounts C1 to C8 of the count values S1 to S8 of the reference pixel signals of the reference pixel 91, corresponding to the count values R1 to R8 of the reset signals of the reference pixel 91. However, because the delay amount at the change point may be assumed to be zero, the delay amounts C of the reference pixel signal amounts S1 to S8 may be calculated using linear approximation according to equation below, thereby reducing the computational load.

Ci=(C8/8)×i, where i=1 to 8.

The number of change points and the slope of the ramp signal Vref changed by the change points may be variously set, as described in the second modified example below. For example, FIGS. 21A and 21B show how the non-linear region (or the non-linear errors) identified in the transition region are managed through a tiered correction strategy that distinguishes between stabilized and unstabilized portions of the ramp signal. For signals that fall into the region that has already stabilized after the slope change, the error is managed as a fixed offset. The count values (e.g., S9 to S14) represent a region where the ramp signal has successfully converged to the target analog gain (e.g., ½) after the change point. Because the distortion has stabilized, the delay amount for this entire region can be set to a constant value, such as the delay amount calculated at the final point of the transition (S8). For signals falling within the non-linear region of the ramp signal, the management is more precise. Count values S1 to S8 correspond to the reference signal amounts within the non-linear transition area that have not yet converged to the stable post-change gain. It is considered advantageous to correct this region by calculating individual delay amounts (C1 to C8) for each specific count value within the transition. To balance the need for accuracy with the requirement for high-speed AD conversion, the device employs a mathematical shortcut. The system assumes the delay amount at the exact moment of the change point is zero. Instead of measuring every single point, the delay amounts (Ci) for the transition counts (S1 to S8) can be calculated using the approximation formula: Ci=(C8/8)×i (where i=1 to 8). This approximation significantly reduces the computational load on the driving control circuit while still suppressing the degradation of AD conversion accuracy.

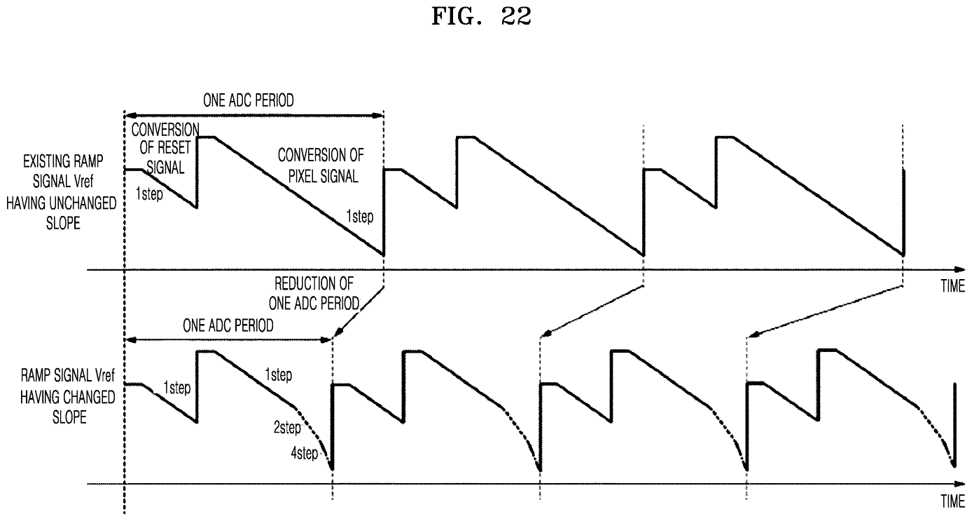

FIGS. 22 to 32 illustrate a comparison between a ramp signal Vref having a changed slope at a change point and an existing ramp signal Vref having an unchanged slope. The upper portions of FIGS. 22 to 32 illustrate existing ramp signals Vref each having an unchanged slope, while the lower portions thereof illustrate ramp signals Vref having changed slopes at change points.

In the example illustrated in FIG. 22, the slope is changed twice in a region of the ramp signal Vref used for AD conversion of a pixel signal. Specifically, at a first change point, for example, the slope is doubled by doubling the clock frequency and increasing the voltage step twofold, and at a second change point, for example, the slope is quadrupled by quadrupling the clock frequency and increasing the voltage step fourfold. Accordingly, one ADC period is reduced.

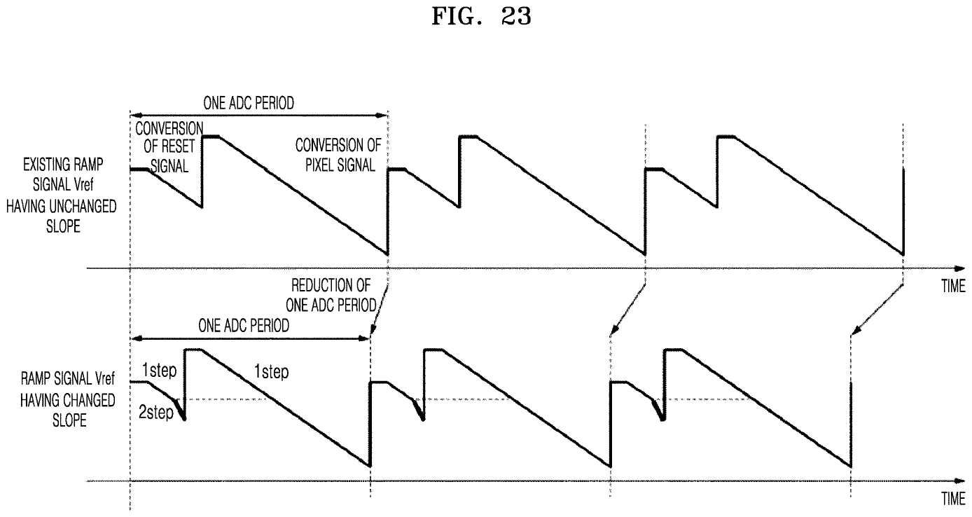

In the example illustrated in FIG. 23, the slope is changed once in a region of the ramp signal Vref used for AD conversion of a reset signal. Specifically, at a change point, for example, the slope is doubled by doubling the clock frequency and increasing the voltage step twofold. Accordingly, one ADC period is reduced.

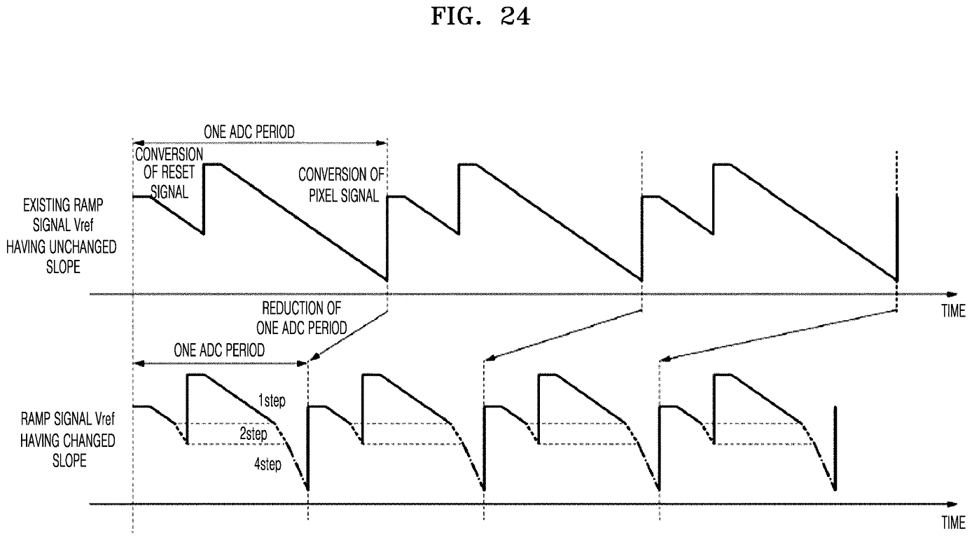

In the example illustrated in FIG. 24, the slope is changed once in a region of the ramp signal Vref used for AD conversion of a reset signal. Additionally, the slope is changed twice in a region of the ramp signal Vref used for AD conversion of a pixel signal. Specifically, in the region of the ramp signal Vref used for AD conversion of the reset signal, at a change point, for example, the slope is doubled by doubling the clock frequency and increasing the voltage step twofold. Additionally, in the region of the ramp signal Vref used for AD conversion of the pixel signal, at the first change point, for example, the slope is doubled by doubling the clock frequency and increasing the voltage step twofold, and at the second change point, for example, the slope is quadrupled by quadrupling the clock frequency and increasing the voltage step fourfold. Accordingly, one ADC period is reduced.

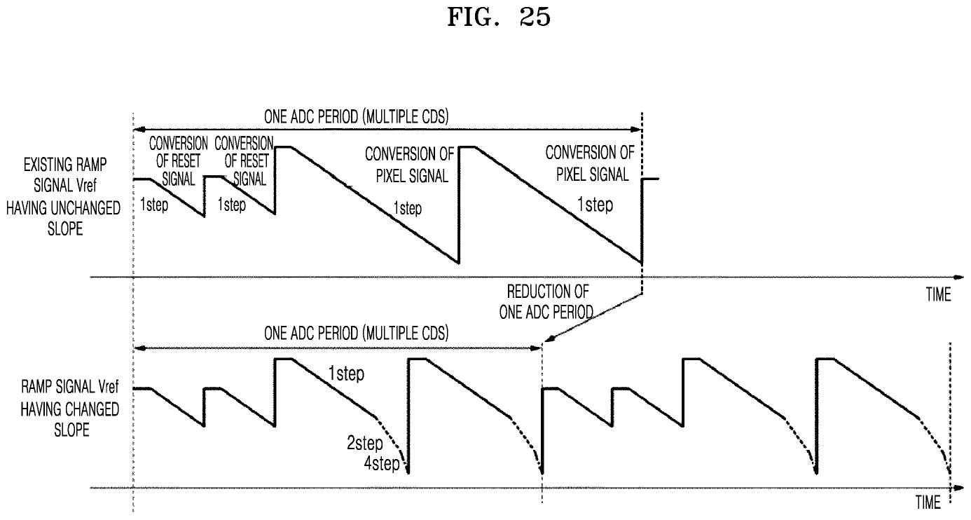

In the example illustrated in FIG. 25, during multiple CDS in which CDS operations are performed multiple times, the slope is changed twice in each of two regions of the ramp signal Vref used for AD conversion of the pixel signal. Specifically, in each of two regions of the ramp signal Vref used for AD conversion of the pixel signal, at the first change point, for example, the slope is doubled by doubling the clock frequency and increasing the voltage step twofold, and at the second change point, for example, the slope is quadrupled by quadrupling the clock frequency and increasing the voltage step fourfold. Accordingly, one ADC period is reduced.

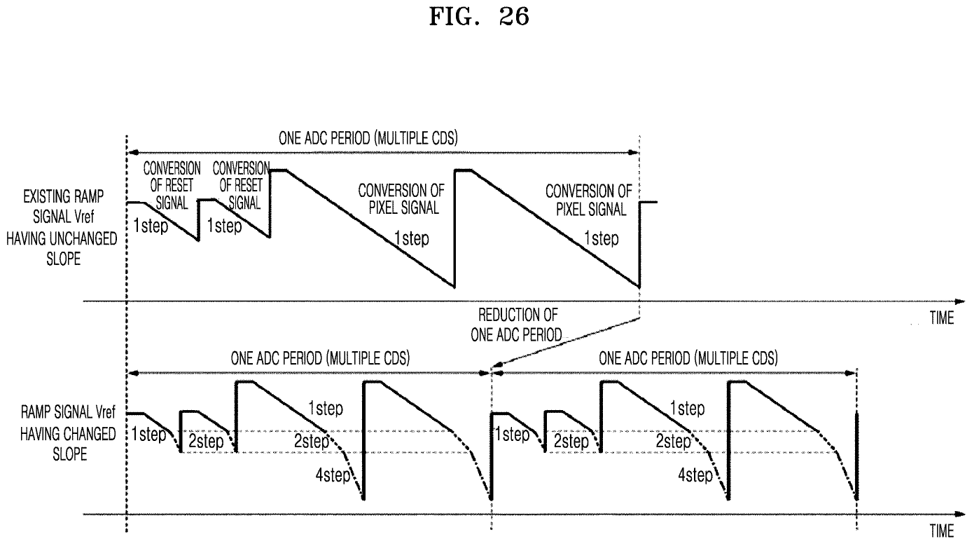

In the example illustrated in FIG. 26, during multiple CDS, the slopes are changed twice in each of two regions of the ramp signal Vref used for AD conversion of the reset signal and two regions of the ramp signal Vref used for AD conversion of the pixel signal. Specifically, in the two regions of the ramp signal Vref used for AD conversion of the reset signal, for example, the slope is doubled at each change point by doubling the clock frequency and increasing the voltage step twofold. Additionally, in the two regions of the ramp signal Vref used for AD conversion of the pixel signal, at the first change point, for example, the slope is doubled by doubling the clock frequency and increasing the voltage step twofold, and at the second change point, for example, the slope is quadrupled by quadrupling the clock frequency and increasing the voltage step fourfold. Accordingly, one ADC period is reduced.

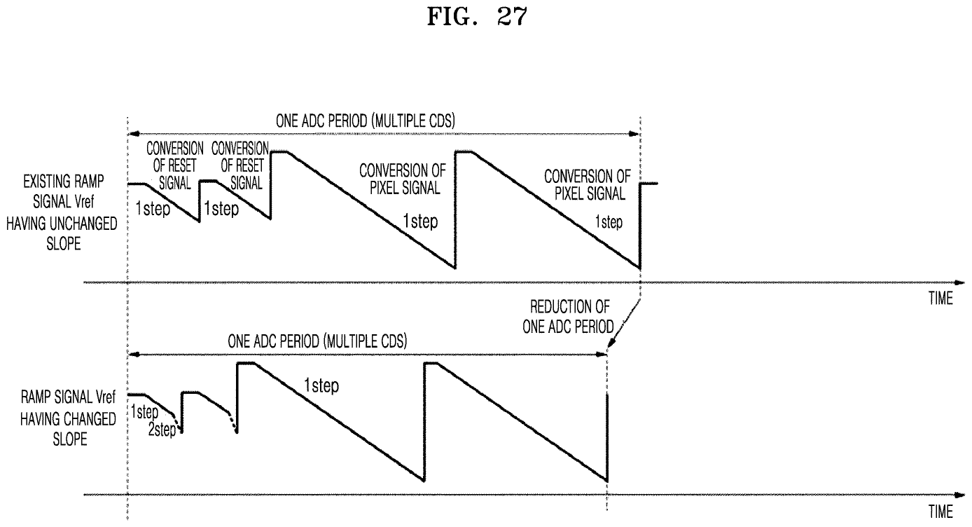

In the example illustrated in FIG. 27, during multiple CDS, the slope is changed once in each of the two regions of the ramp signal Vref used for AD conversion of the reset signal. Specifically, in each of the two regions of the ramp signal Vref used for AD conversion of the reset signal, for example, the slope is doubled by doubling the clock frequency and increasing the voltage step twofold. Accordingly, one ADC period is reduced.

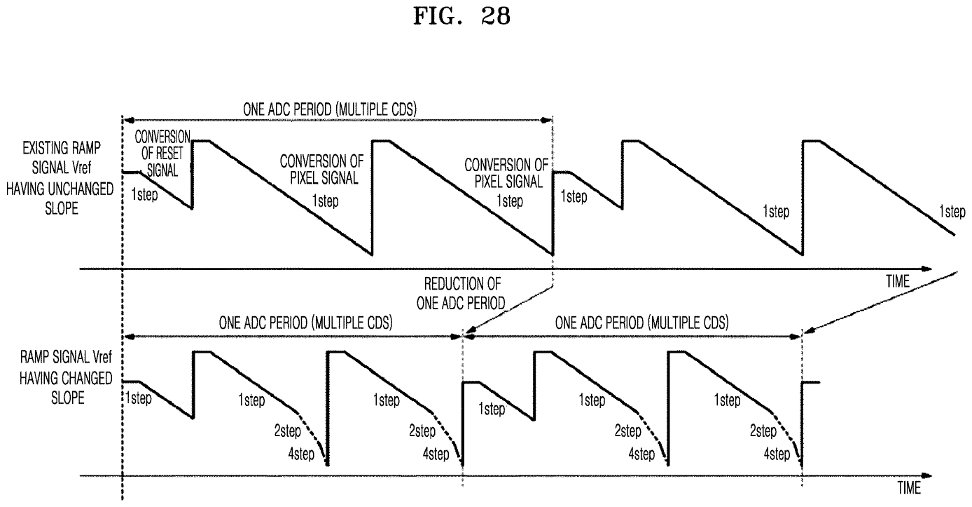

In the example illustrated in FIG. 28, during multiple CDS in which AD conversion of a reset signal is performed once and AD conversion of a pixel signal is performed twice, the slope is changed twice in each of the two regions of the ramp signal Vref used for AD conversion of the pixel signal. Specifically, in each of two regions of the ramp signal Vref used for AD conversion of the pixel signal, at the first change point, for example, the slope is doubled by doubling the clock frequency and increasing the voltage step twofold, and at the second change point, for example, the slope is quadrupled by quadrupling the clock frequency and increasing the voltage step fourfold. Accordingly, one ADC period is reduced.

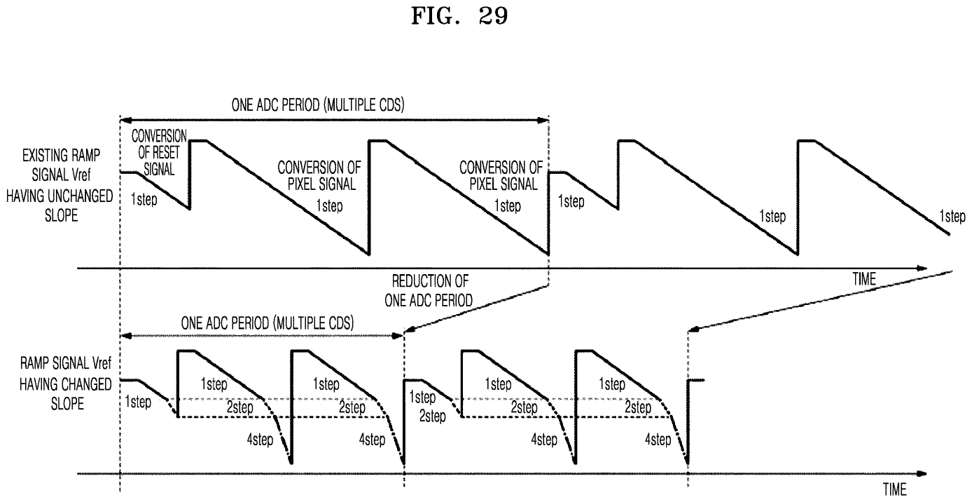

In the example illustrated in FIG. 29, during multiple CDS in which AD conversion of a reset signal is performed once and AD conversion of a pixel signal is performed twice, the slope is changed once in one region of the ramp signal Vref used for AD conversion of the reset signal, while the slope is changed twice in each of the two regions of the ramp signal Vref used for AD conversion of the pixel signal. Specifically, in one region of the ramp signal Vref used for AD conversion of the reset signal, for example, the slope is doubled at a change point by doubling the clock frequency and increasing the voltage step twofold. Additionally, in each of the two regions of the ramp signal Vref used for AD conversion of the pixel signal, at the first change point, for example, the slope is doubled by doubling the clock frequency and increasing the voltage step twofold, and at the second change point, for example, the slope is quadrupled by quadrupling the clock frequency and increasing the voltage step fourfold. Accordingly, one ADC period is reduced.

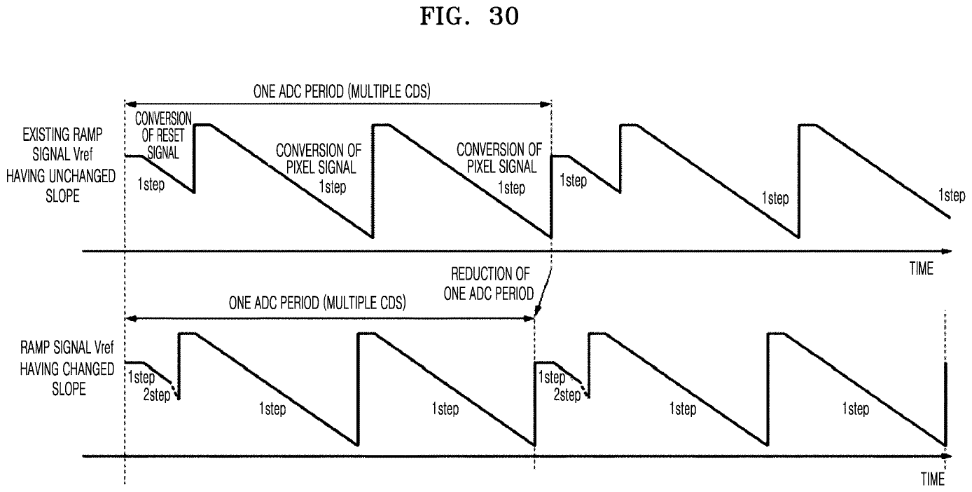

In the example illustrated in FIG. 30, during multiple CDS in which AD conversion of a reset signal is performed once and AD conversion of a pixel signal is performed twice, the slope is changed once in a single region of the ramp signal Vref used for AD conversion of the reset signal. Specifically, in a single region of the ramp signal Vref used for AD conversion of the reset signal, the slope is doubled at a change point by doubling the clock frequency and increasing the voltage step twofold. Accordingly, one ADC period is reduced.

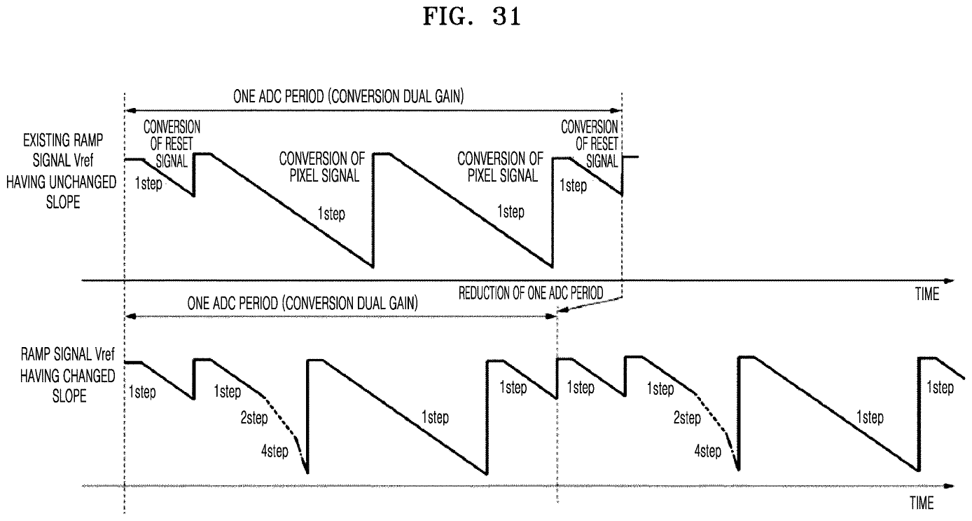

In the example illustrated in FIG. 31, during a Dual Conversion Gain (DCG) operation in which a conversion gain is changed according to ambient illumination to convert received light into an electrical signal, the slope is changed twice in one of two regions of the ramp signal Vref used for AD conversion of a pixel signal. Specifically, in one of the two regions of the ramp signal Vref used for AD conversion of the pixel signal, at a first change point, for example, the slope is doubled by doubling the clock frequency and increasing the voltage step twofold, and at the second change point, for example, the slope is quadrupled by quadrupling the clock frequency and increasing the voltage step fourfold. Accordingly, one ADC period is reduced.

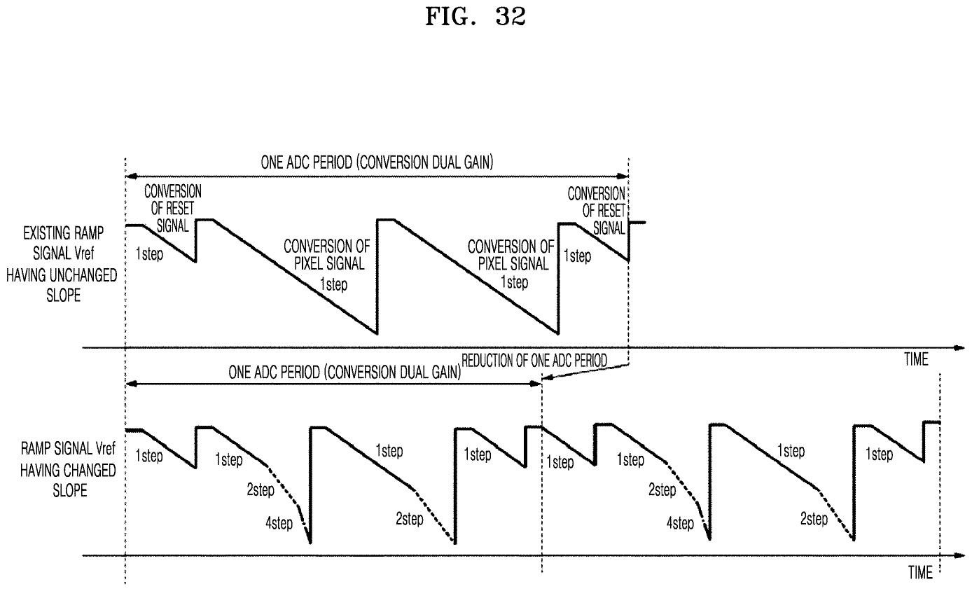

In the example illustrated in FIG. 32, during the DCG operation, the slope is changed twice in one of two regions of the ramp signal Vref used for AD conversion of a reset signal, and the slope is changed once in the other region. Specifically, in one of the two regions of the ramp signal Vref used for AD conversion of the pixel signal, at the first change point, for example, the slope is doubled by doubling the clock frequency and increasing the voltage step twofold, and at the second change point, for example, the slope is quadrupled by quadrupling the clock frequency and increasing the voltage step fourfold. In addition, in the other region of the two regions of the ramp signal Vref used for AD conversion of the pixel signal, the slope is doubled at a change point by doubling the clock frequency and increasing the voltage step twofold. Accordingly, one ADC period is reduced.

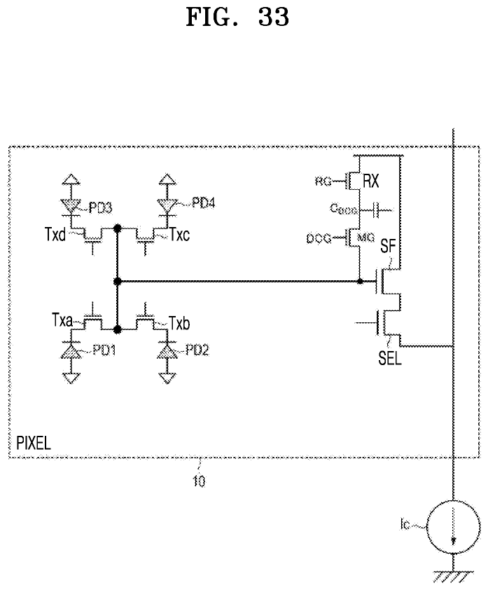

FIG. 33 illustrates an example of a split-photodiode (PD) structure in which Dual Conversion Gain (DCG) is implemented.

In the example illustrated in FIG. 33, a pixel 11 includes four photodiodes PD1 to PD4, where three photodiodes PD1 to PD3 form a Large Photodiode (LPD), and a single photodiode PD4 forms a Small Photodiode (SPD). In an environment with relatively low illuminance, a pixel signal of the LPD having high sensitivity is detected with a relatively high conversion gain. When a pixel signal is detected by the LPD, as the illuminance increases, the mode may transition from a high-gain mode in which the highest conversion gain is achieved without turning on a transistor MG to a middle-gain mode in which a conversion gain is increased by turning on the transistor MG and then connecting the capacitance C_{DCG} to the floating diffusion region FD. In an environment with relatively high illuminance, a pixel signal of an SPD is detected with a relatively low conversion gain. In this case, a Lateral Overflow Integration Capacitor (Lofic) having greater capacitance than capacitance C_{DCG} may be connected to the floating diffusion region FD. Accordingly, the dynamic range of the pixel 11 may be improved.

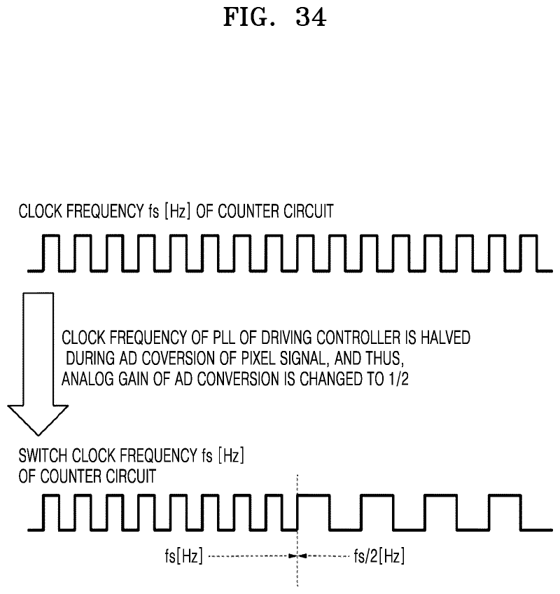

FIG. 34 illustrates a structure in which an analog gain of AD conversion is changed to one half by reducing a clock frequency of the counter circuit 30 to ½.

In the example illustrated in FIG. 34, an analog gain of AD conversion is doubled by reducing a clock frequency fs of a Phase Locked Loop (PLL) of the driving control circuit 80 to ½ during AD conversion of a pixel signal. Accordingly, this may be equivalent to doubling the slope of the ramp signal Vref.

The embodiment provides the following effects.

At a certain change point, the slope of the ramp signal is changed, and a non-linear region generated by the slope change of the ramp signal is corrected using reference pixel signals output from reference pixels. Accordingly, the time required for AD conversion may be shortened while suppressing degradation in the AD conversion accuracy of pixel signals.

In addition, when the pixel signal does not reach the change point, the non-linear region of the ramp signal is not corrected. Accordingly, the computational load is reduced, and the time required for AD conversion may be further reduced.

Also, when the pixel signal reaches the change point, the non-linear region of the ramp signal is corrected. Accordingly, an effect of suppressing degradation in the AD conversion accuracy of pixel signals may be secured.

In addition, the ramp signal is compared with the reference pixel signal, and based on the comparison result, the reference pixel signal is converted into a reference pixel signal amount, a difference between the ideal value of the ramp signal and the reference pixel signal amount is calculated as a delay amount, the ideal value being calculated based on the change point and the slope after the change point, and the non-linear region is corrected using the delay amount. Accordingly, the time required for AD conversion may be shortened more simply and effectively while suppressing a decrease in the AD conversion accuracy of pixel signals.

In addition, reference pixels are arranged in an array in columns common to pixels, and a non-linear region is corrected for each column by using a delay amount calculated for each column. Accordingly, an effect of suppressing a decrease in the AD conversion accuracy of pixel signals may be improved.

In addition, reference pixels are arranged in an array in columns common to pixels, and a non-linear region is corrected by using an average or a median of the delay amounts calculated for respective columns. Accordingly, the computational load may be reduced, and the time required for AD conversion of pixel signals may be shortened while suppressing degradation in the AD conversion accuracy of pixel signals.

In an embodiment, the driving control circuit is configured to correct the non-linear region by calculating the delay amount for each column of the plurality of columns of the pixel array.

In an embodiment, the driving control circuit is configured to correct the non-linear region by calculating an average of the delay amount calculated for each column of the plurality of columns of the pixel array.

In an embodiment, a solid-state imaging device includes a pixel array including a plurality of pixels arranged in a row direction and a column direction, a reference pixel array configured to output a reference pixel signal, a ramp generator configured to generate a ramp signal having a slope that changes from a first slope to a second slope at a change point to perform analog-to-digital (AD) conversion of signals from the pixel array and the reference pixel array, a memory configured to store a delay amount, the delay amount being a difference between a measured signal amount of the reference pixel signal and an ideal value calculated based on the second slope, and a correction unit configured to compare a digital pixel value from the pixel array with a change point setting value of the change point, and correct the digital pixel value using the delay amount and a gain restoration factor when the digital pixel value reaches the change point to generate a corrected signal component.

While the disclosure has been particularly shown and described with reference to embodiments thereof, it will be understood that various changes in form and details may be made therein without departing from the spirit and scope of the following claims.

What is claimed is:

1. A solid-state imaging device comprising:
a reference pixel configured to output a reference pixel signal;
a ramp generator configured to output a ramp signal having a slope that changes from a first slope to a second slope at a change point;
a comparator configured to compare the ramp signal with a pixel signal generated from a pixel;
a counter configured to receive a comparison result from the comparator and generate a counter value as a digital pixel value of the pixel signal; and
a driving control circuit configured to correct, based on the reference pixel signal, a non-linear region that occurs as the slope of the ramp signal is changed.

2. The solid-state imaging device of claim 1,
wherein the driving control circuit is configured to determine whether to correct the non-linear region by comparing a change point setting value of the change point with the digital pixel value of the pixel signal.

3. The solid-state imaging device of claim 2,
wherein the driving control circuit is configured:
when the digital pixel value of the pixel signal does not reach the change point setting value of the change point, not to correct the non-linear region of the ramp signal; and
when the digital pixel value of the pixel signal reaches the change point setting value of the change point, to correct the non-linear region of the ramp signal.

4. The solid-state imaging device of claim 1,
wherein the comparator is configured to compare the ramp signal with the reference pixel signal,
wherein the counter is configured to convert the reference pixel signal into a digital reference pixel value, based on a comparison result of the ramp signal and the reference pixel signal,
wherein the driving control circuit is configured to:
calculate a difference between an ideal value of the ramp signal and the digital reference pixel value as a delay amount, and
correct the non-linear region by using the delay amount, and
wherein the ideal value is calculated based on a clock count of the change point and the second slope after the slope of the ramp signal changes.

5. The solid-state imaging device of claim 4,
wherein the reference pixel is arranged in an array in columns common to the pixel, and
wherein the driving control circuit is configured to correct the non-linear region for each column by using the delay amount calculated for each column.

6. The solid-state imaging device of claim 4,
wherein the reference pixel is arranged in an array in columns common to the pixel, and
wherein the driving control circuit is configured to correct the non-linear region by using an average or a median of the delay amount calculated for each column.

7. A solid-state imaging device comprising:
a pixel array comprising a plurality of pixels arranged in a plurality of columns and a plurality of rows;
a reference pixel array comprising a plurality of reference pixels arranged in the plurality of columns and a plurality of rows;
a ramp generator configured to output a ramp signal having a slope that changes from a first slope to a second slope at a first change point;
a driving control circuit configured to correct a non-linear region of the ramp signal after the first change point; and
a memory configured to store data used to correct the non-linear region.

8. The solid-state imaging device of claim 7,
wherein the memory comprises:
a first memory configured to store a reset inversion clock count and a reference pixel signal amount for each reference pixel of the plurality of reference pixels; and
a second memory configured to store a delay amount corresponding to a difference between an average of reference pixel signal amounts and an ideal value for each row.

9. The solid-state imaging device of claim 8,
wherein the second memory is configured to store:
a first delay amount corresponding to a first row of the plurality of reference pixels;
a second delay amount corresponding to a second row of the plurality of reference pixels; and
an n-th delay amount corresponding to an n-th row of the plurality of reference pixels,
wherein n is a natural number representing a row number, and
wherein the first delay amount is less than the second delay amount.

10. The solid-state imaging device of claim 8,
wherein the ideal value corresponds to a reference pixel signal amount calculated based on the second slope.

11. The solid-state imaging device of claim 10,
wherein an ideal value for each row of the plurality of reference pixels is different from ideal values for the other rows.

12. The solid-state imaging device of claim 9,
wherein the driving control circuit is configured to:
compare a digital pixel value of each pixel of the plurality of pixels with the first change point; and
when the digital pixel value is equal to or greater than the first change point, correct the non-linear region of the ramp signal after the first change point.

13. The solid-state imaging device of claim 12,
wherein the driving control circuit is configured to, when a difference between the digital pixel value and the first change point is the first delay amount or less, calculate a signal component after correction, which is obtained by correcting the non-linear region, and output the signal component.

14. The solid-state imaging device of claim 13,
wherein, when the difference between the digital pixel value and the first change point is greater than the first delay amount, the difference is compared with the second delay amount that is different from the first delay amount, and a signal component after correction, which is obtained by correcting the non-linear region, is calculated and output according to a comparison result.

15. The solid-state imaging device of claim 7,
wherein the memory comprises:
a first memory configured to store a reset inversion clock count and a reference pixel signal amount for each reference pixel of the plurality of reference pixels; and
a second memory configured to store a delay amount corresponding to a difference between the reference pixel signal amount and an ideal value, and
wherein the reset inversion clock count, the reference pixel signal amount, and the delay amount are calculated for each of the plurality of columns.

16. The solid-state imaging device of claim 7,
wherein the first change point is located at a region of the ramp signal that corresponds to analog-to-digital (AD) conversion of a pixel signal.

17. The solid-state imaging device of claim 16,
wherein the ramp signal includes a second change point which is located at a region of the ramp signal that corresponds to AD conversion of a reset signal.

18. A solid-state imaging device comprising:
a pixel array comprising a plurality of pixels arranged in a plurality of columns and a plurality of rows;
a reference pixel array comprising a plurality of reference pixels arranged in the plurality of columns and a plurality of rows;
a ramp generator configured to output a ramp signal having a slope that changes at a change point; and
a driving control circuit configured to correct a non-linear region of the ramp signal after the change point, based on outputs from the plurality of reference pixels,
wherein a light-blocking layer is provided on the plurality of reference pixels.

19. The solid-state imaging device of claim 18,
wherein the driving control circuit is configured to determine whether to correct the non-linear region based on whether outputs from the plurality of pixels are greater or smaller than the change point.

20. The solid-state imaging device of claim 19,
wherein the driving control circuit is configured to determine a delay amount based on the outputs from the plurality of reference pixels and correct the non-linear region by using the delay amount.
